(19) United States
(12) Patent Application Publication
(10) Pub. No.: US 2024/0121688 A1
(43) Pub. Date: Apr. 11, 2024

(54) USER EQUIPMENT TRIGGERED L1 MEASUREMENT AND REPORTING FOR L1/L2 INTER-CELL MOBILITY

(71) Applicant: QUALCOMM Incorporated, San Diego, CA (US)

(72) Inventors: Shanyu Zhou, San Diego, CA (US); Jelena Damnjanovic, Del Mar, CA (US); Ozcan Ozturk, San Diego, CA (US); Yan Zhou, San Diego, CA (US)

(21) Appl. No.: 18/459,512

(22) Filed: Sep. 1, 2023

Related U.S. Application Data
(60) Provisional application No. 63/378,720, filed on Oct. 7, 2022.

(51) Int. Cl. H04W 36/30; H04W 36/00; H04W 36/08

(52) U.S. Cl. CPC H04W 36/302; H04W 36/0058; H04W 36/08

(57) ABSTRACT

Techniques related to user equipment triggered layer 1 measurements for inter-cell mobility are disclosed. Some aspects of the disclosure relate to devices and methods for determining, at a user equipment, that a first condition is triggered for performing one or more layer 1 signal measurements for inter-cell mobility, performing the one or more L1 signal measurements of one or more cells in a configured cell set for the user equipment based on determining that the first condition is triggered, and sending a report of the one or more L1 signal measurements to a network node.

This application claims the benefit of U.S. Provisional Patent Application No. 63/378,720, filed Oct. 7, 2022, the entire content of which is incorporated by reference herein.

### TECHNICAL FIELD

This disclosure relates generally to wireless communication systems, and more particularly, to techniques for triggering layer (L1) signal measurements at a user equipment (UE) for inter-cell mobility.

### BACKGROUND

As the demand for mobile broadband access continues to increase, research and development continue to advance wireless communication technologies not only to meet the growing demand for mobile broadband access, but to advance and enhance the user experience with mobile communications.

### SUMMARY

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

In general, this disclosure describes techniques for performing inter-cell mobility processes between a user equipment (UE) and a network node. In particular, this disclosure describes devices and techniques for updating a serving cell (e.g., a special cell SpCell) through which the UE communicates with the network node, where the update is performed through layer 1 (L1) or layer 2 (L2) signaling from the network node to the UE. A network node may configure a set of cells (e.g., a configured cell set) which includes a subset of activated cells over which the UE and network node perform data and control communication. The network node may designate one of the activated cells as the serving cell. Those cells in the configured cell set that are not in the activated cell set are in the deactivated cell set.

The network node may periodically update both the serving cell within the activated cell set, as well as update which of the configured cell set are part of the activated cell set. That is, the network node may change which cell of the activated cell set is the serving cell. The network node may also move one or more cells from the activated cell set to the deactivated cell set, and vice versa. As part of the making the determination of a serving cell update and/or activated cell set update, the network node may receive L1 signal measurements of one or more of the cells in the configured cell set from the UE. That is, the UE may be configured to perform L1 signal measurements on both activated and deactivated cells and send a report to the network node of the L1 signal measurements. The signal measurement may include a signal to interference and noise ratio (SINR) measurement and/or a reference signal received power (RSRP) measurement. The UE may be configured to send the report to the network node via a downlink control information (DCI) signal (e.g., L1 signaling) or through a media access control (MAC) control element (CE) signal (e.g., L2 signaling).

In accordance with the techniques of this disclosure, the UE may be configured with one or more conditions that allow the UE to trigger L1 signal measurements of the cells in the configured cell set without direct instruction from the network node. The conditions that trigger the cell signal measurements may include or more of a UE mobility condition, a channel strength measurement condition, and/or a predicted block condition. The network node may preconfigure the UE with the conditions that trigger the cell signal measurements. In addition, the network node may preconfigure to the UE with one or more reporting configurations that indicate a reporting format for reporting the L1 signal measurements. The UE may be configured to determine a specific reporting configuration based on one or more conditions, which may be the same as the conditions used to trigger the L1 signal measurements or may be different conditions. The network node may also preconfigure the resources (e.g., time, frequency, beam, etc.) over which the UE will transmit reports of the UE-triggered L1 signal measurements.

By preconfiguring the UE with conditions to trigger and report L1 signal measurements, the network node may receive such L1 signal measurements in a timelier fashion compared to techniques where the network node explicitly requests the L1 signal measurements. As such, the techniques of this disclosure may facilitate faster serving cell updates (e.g., SpCell updates) for L1/L2 inter-cell mobility, as well as may facilitate faster beam management, timing synchronization, and power control.

In one example, this disclosure describes a user equipment (UE) for wireless communication, the UE comprising a memory, and a processor in communication with the memory, the processor configured to determine that a first condition is triggered for performing one or more layer 1 (L1) signal measurements for inter-cell mobility, perform the one or more L1 signal measurements of one or more cells in a configured cell set for the UE based on determining that the first condition is triggered, and send a report of the one or more L1 signal measurements to a network node.

In another example, this disclosure describes a method for wireless communication, the method comprising determining, at a user equipment (UE), that a first condition is triggered for performing one or more layer 1 (L1) signal measurements for inter-cell mobility, performing the one or more L1 signal measurements of one or more cells in a configured cell set for the UE based on determining that the first condition is triggered, and sending a report of the one or more L1 signal measurements to a network node.

In another example, this disclosure describes an apparatus comprising means for determining, at a user equipment (UE), that a first condition is triggered for performing one or more layer 1 (L1) signal measurements for inter-cell mobility, means for performing the one or more L1 signal measurements of one or more cells in a configured cell set for the UE based on determining that the first condition is triggered, and means for sending a report of the one or more L1 signal measurements to a network node.

In another example, this disclosure describes a non-transitory computer-readable storage medium storing instructions that, when executed, cause one or more processors to determine that a first condition is triggered for performing one or more layer 1 (L1) signal measurements for inter-cell mobility, perform the one or more L1 signal measurements of one or more cells in a configured cell set for the UE based on determining that the first condition is triggered, and send a report of the one or more L1 signal measurements to a network node.

In another example, this disclosure describes a network node for wireless communication, the network node comprising a memory, and a processor in communication with the memory, the processor configured to send, to a user equipment (UE), one or more conditions for triggering one or more layer 1 (L1) signal measurements of one or more cells in a configured cell set for the UE for inter-cell mobility, receive, from the UE, a report of the one or more L1 signal measurements, and perform an inter-cell mobility operation based on the one or more L1 signal measurements.

In another example, this disclosure describes a method for wireless communication, the method comprising sending, to a user equipment (UE), one or more conditions for triggering one or more layer 1 (L1) signal measurements of one or more cells in a configured cell set for the UE for inter-cell mobility, receiving, from the UE, a report of the one or more L1 signal measurements, and performing an inter-cell mobility operation based on the one or more L1 signal measurements.

In another example, this disclosure describes an apparatus comprising means for sending, to a user equipment (UE), one or more conditions for triggering one or more layer 1 (L1) signal measurements of one or more cells in a configured cell set for the UE for inter-cell mobility, means for receiving, from the UE, a report of the one or more L1 signal measurements, and means for performing an inter-cell mobility operation based on the one or more L1 signal measurements

In another example, this disclosure describes anon-transitory computer-readable storage medium storing instructions that, when executed, cause one or more processors to send, to a user equipment (UE), one or more conditions for triggering one or more layer 1 (L1) signal measurements of one or more cells in a configured cell set for the UE for inter-cell mobility, receive, from the UE, a report of the one or more L1 signal measurements, and perform an inter-cell mobility operation based on the one or more L1 signal measurements.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF DRAWINGS

FIG. 1 is a schematic illustration of a wireless communication system according to some aspects of this disclosure.

FIG. 2 is a conceptual illustration of an example of a radio access network according to some aspects of this disclosure.

FIG. 3 is a conceptual diagram illustrating an example disaggregated base station architecture according to some aspects of this disclosure.

FIG. 4 is an illustration of a user plane protocol stack and a control plane protocol stack in accordance with some aspects of this disclosure.

FIG. 5 is an schematic illustration of an OFDM waveform in accordance with various aspects of the present disclosure.

FIG. 6 is a schematic illustration of inter-cell mobility in accordance with various aspects of the present disclosure.

FIG. 7 is a block diagram conceptually illustrating an example of a hardware implementation for a network node according to some aspects of this disclosure.

FIG. 8 is a block diagram conceptually illustrating an example of a hardware implementation for a user equipment (UE) according to some aspects of this disclosure.

FIG. 9 is a flowchart illustrating an example of a process for UE-triggered L1 signal measurements for inter-cell mobility according to some aspects of this disclosure.

FIG. 10 is a flowchart illustrating an example of a process for configuring conditions for UE-triggered L1 signal measurements for inter-cell mobility according to some aspects of this disclosure.

### DETAILED DESCRIPTION

In L1/L2 inter-cell mobility, a network node may update a serving cell over which a UE may communicate with the network node using L1 and/or L2 signaling. L1 signaling may include a downlink control information (DCI) signal and L2 signaling may include a media access control (MAC) control element (CE) signal. The network node may send the L1/L2 signaling to the UE through the current serving cell (e.g., a special cell (SpCell). L1/L2 inter-cell mobility may be contrasted with other forms of inter-cell mobility, where serving cells may be updated using layer 3 radio resource control (RRC) signaling. In some examples, serving cells may be referred to as candidate lower-layer triggered mobility (LTM) cells.

A UE may be configured to communicate with the network node through one or more cells in a configured cell set. In the context of this disclosure, the term cell is generic term, and may be considered a radio unit (RU), a radio head, a Tx/Rx point (TRP), or a physical cell ID (PCI). In some examples, the cells in a configured cell set may be the same cell on different frequencies.

A network node may configure a set of cells that support L1/L2 mobility through radio resource control (RRC) signaling to a UE. In this example, the cells that support L1/L2 mobility are called a configured cell set. The cells in configured cell set may be configured to have an SpCell (special cell) configuration. An SpCell is a combination of a primary cell (PCell) and a primary second cell (PSCell). A PCell may be used in an master cell group (MCG) and a PSCell is used in a secondary cell group (SCG). MCGs and SCGs are concepts used in dual connectivity and/or multi connectivity, where a UE may be connected to two or more network nodes. An MCG includes a group of serving cells associated with a Master Node. The SCG may include a group of serving cells associated with a Secondary Node. A PCell is used to initiate initial access to a network node in an MCG. A PSCell is used to perform initial access under an SCG. The SpCell performs the functions of both a PCell and a PSCell. The SpCell may support physical uplink control channel (PUCCH) transmission and contention-based random access, and may also be activated. The cells in the configured cell set may be on the same carrier frequency or on different carrier frequencies. As such, the techniques of this disclosure are applicable for use with inter-cell carrier aggregation or intra-cell carrier aggregation.

The configured cell set may include an activated cell set as well as a deactivated cell set. The deactivated cell set are the cells of the configured cell set that are not in the activated cell set. The cells within the activated cell set can be used for data and/or control transmissions and SpCell update via L1/L2 signaling. That is, the UE and the network node may communicate data and control information through the cells in the activated cell set.

The deactivated cell set are a group of cells in the L1/L2 mobility configured set that cannot be used for data and control transmission and reception, but can be activated and used for SpCell update via L1/L2 signaling. In addition, a UE may be configured to perform L1 signal measurements on the cells in the deactivated cell set as well as the cells in the activated cell set. The UE would report any L1 signal measurements on the cells in the deactivated cell set via one or more cells in activated cell set. The UE may be configured to send the report to the network node via a DCI signal (e.g., L1 signaling) or through a MAC CE signal (e.g., L2 signaling).

In L1/L2 inter-cell mobility, deactivated cells in configured cell set can support L1 signal measurements. The UE may perform the L1 signal measurements and report such measurements to the network node in order to facilitate sufficient beam management, timing synchronization, power control, and SpCell functionality activation. When an L1/L2 mobility cell is in the deactivated cell set, the UE performs L1 signal measurement reporting for such a cell via an activated cell in the activated cell set. In some example techniques, which deactivated cells configured for L1/L2 mobility on which the UE performs L1 signal measurement reporting, as well as a type of reporting configuration to use, is determined by signaling from the network node. For example, measurement and reporting is configured by the network node and aperiodic measurement and reporting may be triggered by signaling from the network node.

Using direct signaling from a network node to instruct a UE to make L1 signal measurements for cells for L1/L2 mobility may not allow for fast SpCell update in all scenarios. This is because actions by the UE (e.g., mobility) as well as changes in channel conditions may be more quickly detected by the UE than the network node. This disclosure describes techniques wherein the UE is configured to trigger and report L1 signal measurements on cells in a configured cell set for L1/L2 mobility.

In accordance with the techniques of this disclosure, a UE may be configured with one or more conditions that allow the UE to trigger L1 signal measurements of the cells in the configured cell set without direct instruction from a network node. The conditions that trigger the cell signal measurements may include or more of UE mobility condition, a channel strength measurement condition, and/or a predicted block condition. The network node may preconfigure the UE with the conditions that trigger the cell signal measurements. In addition, the network node may preconfigure the UE with one or more reporting configurations that indicate a reporting format for reporting the L1 signal measurements. The UE may be configured to determine a specific reporting configuration based on one or more conditions, which may be the same as the conditions used to trigger the L1 signal measurements or may be different conditions. The network node may also preconfigure the resources (e.g., time, frequency, beam, etc.) over which the UE will transmit reports of the UE-triggered L1 signal measurements.

By preconfiguring the UE with conditions to trigger and report L1 signal measurements, the network node may receive such L1 signal measurements in a timelier fashion compared to techniques where the network node explicitly requests the L1 signal measurements. As such, the techniques of this disclosure may facilitate faster serving cell updates (e.g., SpCell updates) for L1/L2 inter-cell mobility, as well as may facilitate faster beam management, timing synchronization, and power control.

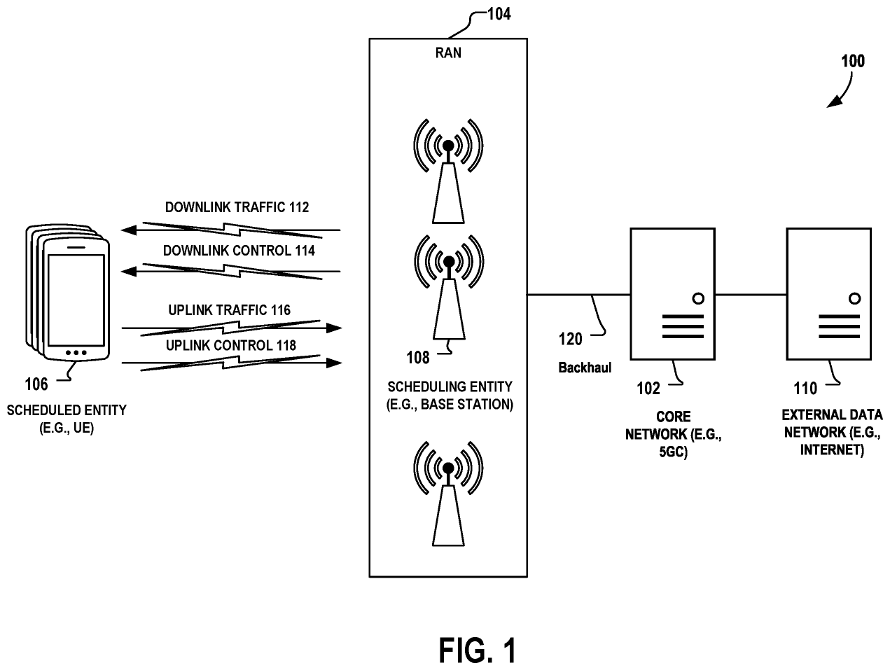

The disclosure that follows presents various devices and techniques for UE triggered L1 measurement and reporting that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 104 includes a plurality of network nodes 108 (also referred to as a “base station”). Broadly, a base station is a network element in a radio access network responsible for radio transmission and reception in one or more cells to or from a UE. In different technologies, standards, or contexts, those skilled in the art may variously refer to a “base station” as a network node, base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a transmit receive point (TRP), a distributed unit (DU), a centralized unit (CU) or some other suitable terminology. In examples of this disclosure, the term “network node” may be used generically to refer to any of the above terms for “base station”.

The radio access network (RAN) 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present disclosure, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between a RAN 104 and a UE 106 may be described as utilizing an air interface. Transmissions over the air interface from a base station (e.g., network node 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., network node 108). Another way to describe this scheme may be to use the term broadcast channel multiplexing. Transmissions from a UE (e.g., UE 106) to a base station (e.g., network node 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a network node 108) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs 106, which may be scheduled entities, may utilize resources allocated by a scheduling entity (e.g., network node 108).

Base stations are not the only entities that may function as scheduling entities. That is, in some examples, a UE or network node may function as a scheduling entity, scheduling resources for one or more scheduled entities (e.g., one or more UEs).

As illustrated in FIG. 1, a network node 108 may broadcast downlink traffic 112 to one or more UEs 106. Broadly, the network node 108 is a node or device responsible for scheduling traffic in a wireless communication network, including downlink traffic 112 and, in some examples, uplink traffic 116 from one or more UEs 106 to the network node 108. On the other hand, the UE 106 is a node or device that receives downlink control information 114, including but not limited to scheduling information (e.g., a grant), synchronization or timing information, or other control information from another entity in the wireless communication network such as the network node 108.

In general, network nodes 108 may include a backhaul interface for communication with a backhaul portion 120 of the wireless communication system. The backhaul 120 may provide a link between a network node 108 and the core network 102. Further, in some examples, a backhaul network may provide interconnection between the respective network nodes 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

As will be explained in more detail below, UE 106 and network node 108 may be configured to perform one or more techniques of UE-triggered inter-cell mobility. In particular, UE 106 and network node 108 may be configured to perform techniques for updating a serving cell (e.g., a special cell SpCell) through which UE 106 communicates with network node 108, where the update is performed through layer 1 (L1) or layer 2 (L2) signaling from network node 108 to UE 106. Network node 108 may configure a set of cells (e.g., a configured cell set) which includes a subset of activated cells over which UE 106 and network node 108 perform data and control communication. Network node 108 may designate one of the activated cells as the serving cell. Those cells in the configured cell set that are not in the activated cell set are in the deactivated cell set.

Network node 108 may periodically update both the serving cell within the activated cell set, as well as update which of the configured cell set are part of the activated cell set. That is, network node 108 may change which cell of the activated cell set is the serving cell. Network node 108 may also move one or more cells from the activated cell set to the deactivated cell set, and vice versa. As part of the making the determination of a serving cell update and/or activated cell set update, network node 108 may receive L1 signal measurements of one or more of the cells in the configured cell set from UE 106. That is, UE 106 may be configured to perform L1 signal measurements on both activated and deactivated cells and send a report to network node 108 of the L1 signal measurements. The signal measurement may include a signal to interference noise ratio (SINR) measurement and/or a reference signal received power (RSRP) measurement. UE may 106 be configured to send the report to network node 108 via a DCI signal (e.g., L1 signaling) or through a MAC CE signal (e.g., L2 signaling).

In accordance with the techniques of this disclosure, UE 106 may be configured with one or more conditions that allow UE 106 to trigger L1 signal measurements of the cells in the configured cell set without direct instruction from network node 108. The conditions that trigger the cell signal measurements may include or more of UE mobility condition, a channel strength measurement condition, and/or a predicted block condition. Network node 108 may preconfigure UE 106 with the conditions that trigger the cell signal measurements. In addition, network node 108 may preconfigure to UE 106 with one or more reporting configurations that indicate a reporting format for reporting the L1 signal measurements. UE 106 may be configured to determine a specific reporting configuration based on one or more conditions, which may be the same as the conditions used to trigger the L1 signal measurements or may be different conditions. Network node 108 may also preconfigure the resources (e.g., time, frequency, beam, etc.) over which UE 106 will transmit reports of the UE-triggered L1 signal measurements.

By preconfiguring UE 106 with conditions to trigger and report L1 signal measurements, network node 108 may receive such L1 signal measurements in a timelier fashion compared to techniques where network node 108 explicitly requests the L1 signal measurements. As such, the techniques of this disclosure may facilitate faster serving cell updates (e.g., SpCell updates) for L1/L2 inter-cell mobility, as well as may facilitate faster beam management, timing synchronization, and power control.

In one example of the disclosure, UE 106 may be configured to determine that a first condition is triggered for performing one or more L1 signal measurements for inter-cell mobility, perform the one or more L1 signal measurements of one or more cells in a configured cell set for the UE based on determining that the first condition is triggered, and send a report of the one or more L1 signal measurements to network node 108. In a reciprocal fashion, network node 108 may be configured to send, to UE 106, one or more conditions for triggering one or more L1 signal measurements of one or more cells in a configured cell set for the UE for inter-cell mobility, receive, from UE 106, a report of the one or more L1 signal measurements, and perform an inter-cell mobility operation based on the one or more L1 signal measurements. In some examples of the disclosure, performing an inter-cell mobility operation may include one or more of updating a serving cell (e.g., an SpCell) in activated cell set of the configured cell set and/or designating particular cells in the configured cell set as being in the activated cell set.

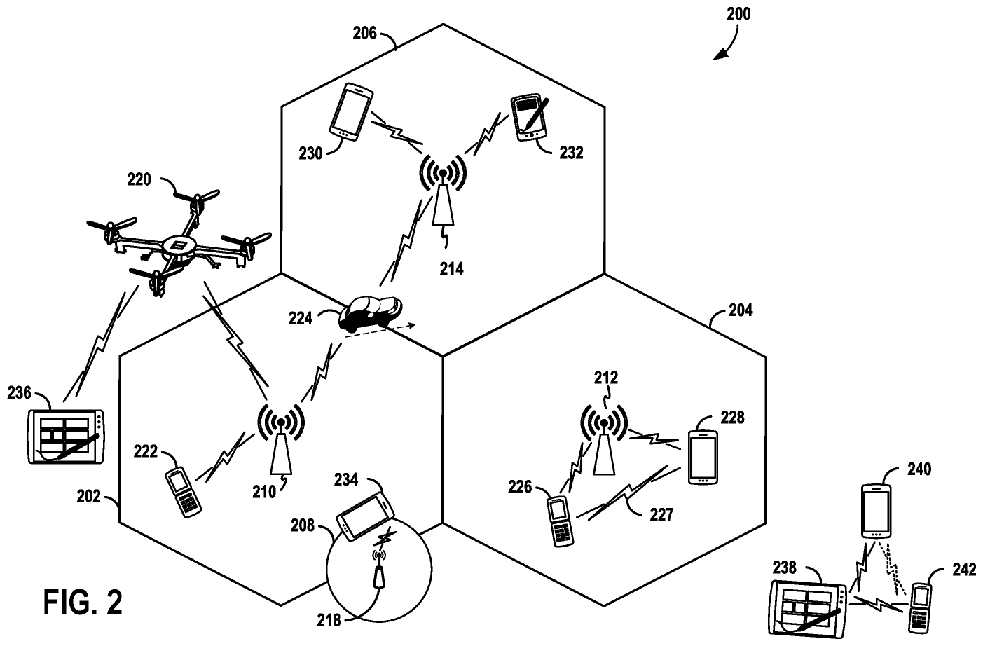

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that UE can uniquely identify based on an identification broadcasted from one network node (e.g., access point, base station, etc.). FIG. 2 illustrates macrocells 202, 204, and 206, and a small cell 208.

FIG. 2 shows two three network nodes 210, and 212, and 214 in cells 202, 204, and 206. In the illustrated example, the cells 202, 204, and 206 may be referred to as macrocells, as the network nodes 210, 212, and 214 support cells having a large size. Further, a network node 218 is shown in the small cell 208 (e.g., a microcell, picocell, femtocell, home base station, home Node B, home eNode B, etc.) which may overlap with one or more macrocells. In this example, the cell 208 may be referred to as a small cell, as the network node 218 supports a cell having a relatively small size. Cell sizing can be done according to system design as well as component constraints.

The RAN 200 may include any number of wireless network nodes and cells. Further, a RAN may include a relay node to extend the size or coverage area of a given cell. The network nodes 210, 212, 214, 218 provide wireless access points to a core network for any number of mobile apparatuses. In some examples, the network nodes 210, 212, 214, and/or 218 may be the same as the network node 108 described above and illustrated in FIG. 1.

FIG. 2 further includes a quadcopter or drone 220, which may be configured to function as a network node. That is, in some examples, a cell may not necessarily be stationary, and the geographic area of the cell may move according to the location of a mobile network node such as the quadcopter 220.

Within the RAN 200, each network node 210, 212, 214, 218, and 220 may be configured to provide an access point to a core network 102 (see FIG. 1) for all the UEs in the respective cells. For example, UEs 222 and 224 may be in communication with network node 210; UEs 226 and 228 may be in communication with network node 212; UEs 230 and 232 may be in communication with network node 214; UE 234 may be in communication with network node 218; and UE 236 may be in communication with mobile network node 220. In some examples, the UEs 222, 224, 226, 228, 230, 232, 234, 236, 238, 240, and/or 242 may be the same as the UE 106 described above and illustrated in FIG. 1.

In some examples, a mobile network node (e.g., quadcopter 220) may be configured to function as a UE. For example, the quadcopter 220 may operate within cell 202 by communicating with network node 210.

In a further aspect of the RAN 200, sidelink signals may be used between UEs without necessarily relying on scheduling or control information from a network node (e.g., a scheduling entity). For example, two or more UEs (e.g., UEs 226 and 228) may communicate with each other using peer to peer (P2P) or sidelink signals 227 without relaying that communication through a network node. In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

Open RAN

Deployment of communication systems, such as 5G NR systems, may be arranged in multiple manners with various components or constituent parts. In a 5G NR system, or network, a network node, a network entity, a mobility element of a network, RAN node, a core network node, a network element, or a network equipment, such as a base station BS, or one or more units (or one or more components) performing base station functionality, may be implemented in an aggregated or disaggregated architecture. For example, a base station (BS) (such as a Node B (NB), evolved NB (eNB), NR BS, 5G NB, gNB, access point (AP), a transmit receive point (TRP), or a cell, or generally a network node etc.) may be implemented as an aggregated base station (also known as a standalone BS or a monolithic BS) or a disaggregated base station. The example techniques of this disclosure for UE-triggered L1 measurements for inter-cell mobility may be performed when communicating with an aggregated base station (e.g., network node) or a disaggregated base station (e.g., network node).

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

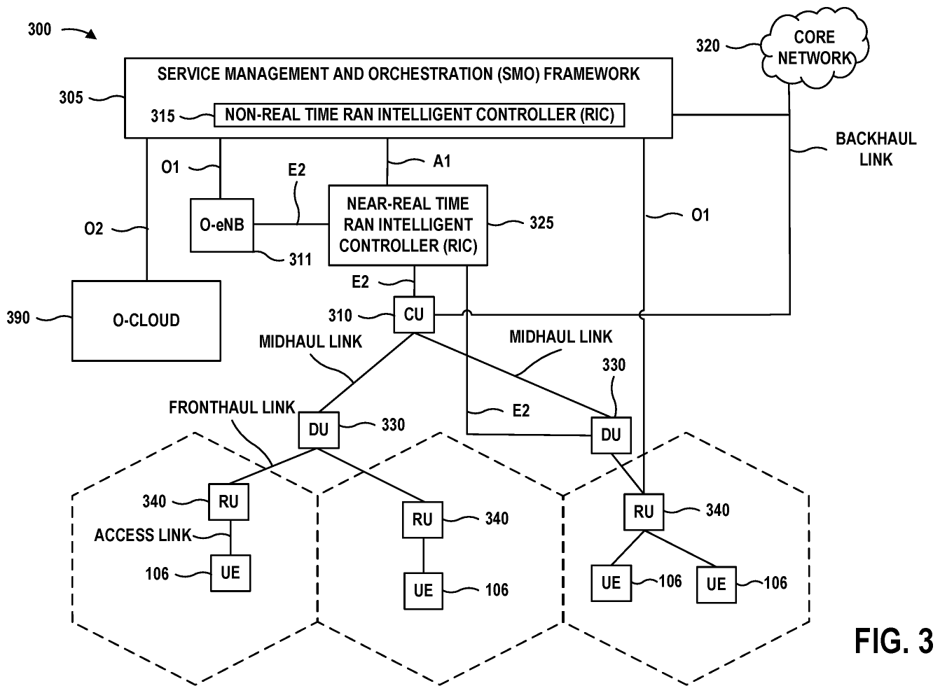

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 106 via one or more radio frequency (RF) access links. In some implementations, the UE 106 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 106. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

Communication Protocol Layers

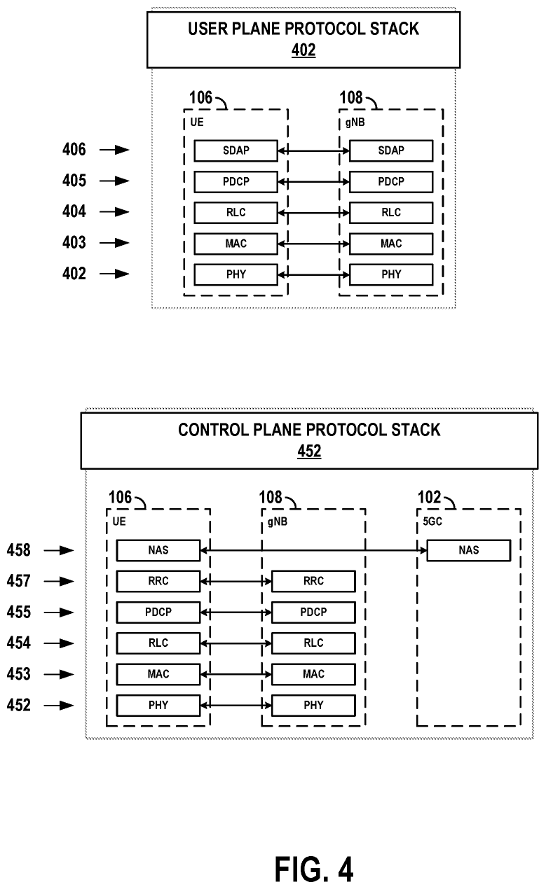

FIG. 4 is a schematic illustration of a user plane protocol stack 402 and a control plane protocol stack 452 in accordance with some aspects of this disclosure. In a wireless telecommunication system, the communication protocol architecture may take on various forms depending on the application. For example, in a 3GPP NR system, the signaling protocol stack is divided into Non-Access Stratum (NAS, 458) and Access Stratum (AS, 402-406 and 452-457) layers and protocols. The NAS protocol 458 provides upper layers, for signaling between a UE 106 and a core network 102 (referring to FIG. 1). The AS protocol 402-406 and 452-457 provides lower layers, for signaling between the RAN 104 (e.g., a gNB or other network node 108) and the UE 106.

Turning to FIG. 4, a radio protocol architecture is illustrated with a user plane protocol stack 402 and a control plane protocol stack 452, showing their respective layers or sublayers. Radio bearers between a network node 108 and a UE 106 may be categorized as data radio bearers (DRB) for carrying user plane data, corresponding to the user plane protocol 402; and signaling radio bearers (SRB) for carrying control plane data, corresponding to the control plane protocol 452.

In the AS, both the user plane 402 and control plane 452 protocols include a physical layer (PHY) 402/452, a medium access control layer (MAC) 403/453, a radio link control layer (RLC) 404/454, and a packet data convergence protocol layer (PDCP) 405/455. PHY 402/452 is the lowest layer and implements various physical layer signal processing functions. PHY 402/452 may also be referred to as layer (L1). The MAC layer 403/453 provides multiplexing between logical and transport channels and is responsible for various functions. For example, the MAC layer 403/453 is responsible for reporting scheduling information, priority handling and prioritization, and error correction through hybrid automatic repeat request (HARQ) operations. The RLC layer 404/454 provides functions such as sequence numbering, segmentation and reassembly of upper layer data packets, and duplicate packet detection. The PDCP layer 405/455 provides functions including header compression for upper layer data packets to reduce radio transmission overhead, security by ciphering the data packets, and integrity protection and verification. MAC layer 403/453, RLC layer 404/454, and PDCP layer 405/455 may be referred to as layer 2 (L2).

In the user plane protocol stack 402, a service data adaptation protocol (SDAP) layer 406 provides services and functions for maintaining a desired quality of service (QoS). And in the control plane protocol stack 452, a radio resource control (RRC) layer 457 includes a number of functional entities for routing higher layer messages, handling broadcasting and paging functions, establishing and configuring radio bearers, NAS message transfer between NAS and UE, etc. RRC layer 457 may also be referred to as layer 3 (L3).

A NAS protocol layer 458 provides for a wide variety of control functions between the UE 106 and core network 102. These functions include, for example, registration management functionality, connection management functionality, and user plane connection activation and deactivation.

PHY Frame Structure

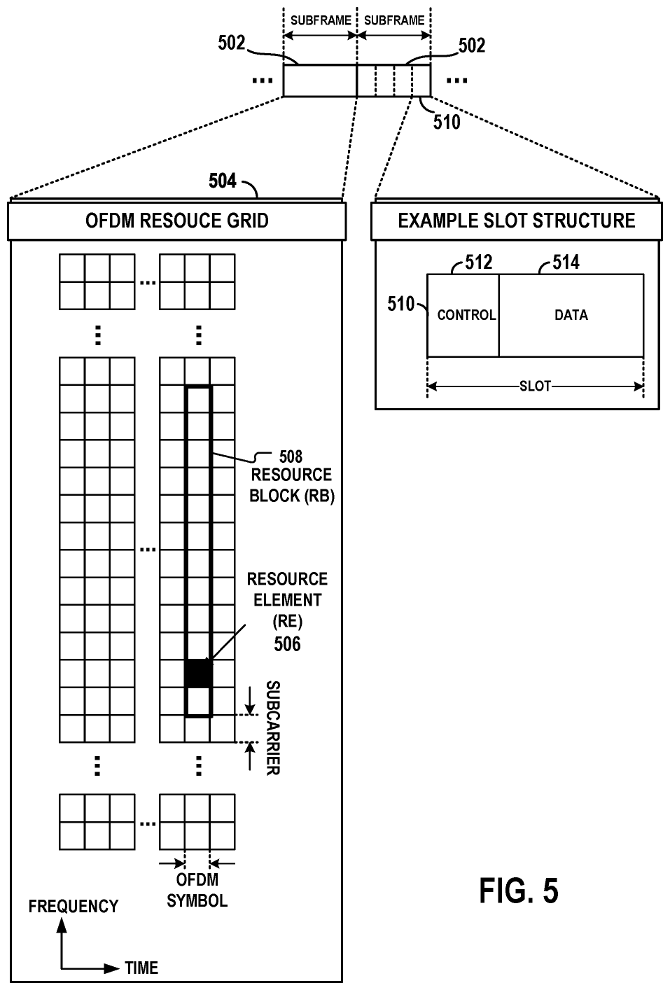

FIG. 5 schematically illustrates various aspects of the present disclosure with reference to an OFDM waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may include a set of subframes (e.g., 10 subframes of 1 ms each). A given carrier may include one set of frames in the UL, and another set of frames in the DL. FIG. 5 illustrates an expanded view of an exemplary DL subframe 502, showing an OFDM resource grid 504. However, as those skilled in the art will readily appreciate, the PHY transmission structure for any application may vary from the example described here, depending on any number of factors. Here, time is in the horizontal direction with units of OFDM symbols; and frequency is in the vertical direction with units of subcarriers or tones.

The resource grid 504 may schematically represent time-frequency resources for a given antenna port. That is, in a MIMO implementation with multiple antenna ports available, a corresponding multiple number of resource grids 504 may be available for communication. The resource grid 504 is divided into multiple resource elements (REs) 506. An RE, which is 1 subcarrier×1 symbol, is the smallest discrete part of the time-frequency grid and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 508, which contains any suitable number of consecutive subcarriers in the frequency domain. In one example, an RB may span 12 subcarriers, a number independent of the numerology used. In some examples, depending on the numerology, an RB may include any suitable number of consecutive OFDM symbols in the time domain.

A given UE generally utilizes only a subset of the resource grid 504. An RB may be the smallest unit of resources that a scheduler can allocate to a UE. Thus, the more RBs scheduled for a UE, and the higher the modulation scheme chosen for the air interface, the higher the data rate for the UE.

In this illustration, RB 508 occupies less than the entire bandwidth of the subframe 502, with some subcarriers illustrated above and below the RB 508. In a given implementation, subframe 502 may have a bandwidth corresponding to any number of one or more RBs 508. Further, the RB 508 is shown occupying less than the entire duration of the subframe 502, although this is merely one possible example.

Each 1 ms subframe 502 may include one or multiple adjacent slots. In FIG. 5, one subframe 502 includes four slots 510, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). A network node may in some cases transmit these mini-slots occupying resources scheduled for ongoing slot transmissions for the same or for different UEs.

An expanded view of one of the slots 510 illustrates the slot 510 including a control region 512 and a data region 514. In general, the control region 512 may carry control channels (e.g., PDCCH), and the data region 514 may carry data channels (e.g., PDSCH or PUSCH). Of course, a slot may contain all DL, all UL, or at least one DL portion and at least one UL portion. The structure illustrated in FIG. 5 is merely exemplary in nature, and different slot structures may be utilized, and may include one or more of each of the control region(s) and data region(s).

Although not illustrated in FIG. 5, the various REs 506 within an RB 508 may carry one or more physical channels, including control channels, shared channels, data channels, etc. Other REs 506 within the RB 508 may also carry pilots or reference signals. These pilots or reference signals may provide for a receiving device to perform channel estimation of the corresponding channel, which may enable coherent demodulation/detection of the control and/or data channels within the RB 508.

In a DL transmission, the transmitting device (e.g., network node 108 of FIG. 1) may allocate one or more REs 506 (e.g., within a control region 512) to carry one or more DL control channels. These DL control channels include DL control information (DCI) 114 (FIG. 1) that generally carries information originating from higher layers, such as a physical broadcast channel (PBCH), a physical downlink control channel (PDCCH), etc., to one or more UEs 106. In addition, the network node may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

A network node may transmit the synchronization signals PSS and SSS (collectively referred to as SS), and in some examples, the PBCH, in an SS block that includes four consecutive OFDM symbols. In the frequency domain, the SS block may extend over 240 contiguous subcarriers. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a UE 106) may utilize one or more REs 506 to carry one or more UL control channels, such as a physical uplink control channel (PUCCH), a physical random access channel (PRACH), etc. These UL control channels include UL control information (UCI) 118 (FIG. 1) that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the network node 108 to schedule uplink transmissions. Here, in response to the SR transmitted on the UL control channel 118 (e.g., a PUCCH), the network node 108 may transmit downlink control information (DCI) 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, one or more REs 506 (e.g., within the data region 514) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. The RAN may provide this system information utilizing minimum system information (MSI), and other system information (OSI). The RAN may periodically broadcast the MSI over the cell to provide the most basic information a UE requires for initial cell access, and for enabling a UE to acquire any OSI that the RAN may broadcast periodically or send on-demand. In some examples, a network may provide MSI over two different downlink channels. For example, the PBCH may carry a master information block (MIB), and the PDSCH may carry a system information block type 1 (SIB1). Here, the MIB may provide a UE with parameters for monitoring a control resource set. The control resource set may thereby provide the UE with scheduling information corresponding to the PDSCH, e.g., a resource location of SIB1. In the art, SIB1 may be referred to as remaining minimum system information (RMSI).

OSI may include any SI that is not broadcast in the MSI. In some examples, the PDSCH may carry a plurality of SIBs, not limited to SIB1, discussed above. Here, the RAN may provide the OSI in these SIBs, e.g., SIB2 and above.

The channels or carriers described above and illustrated in FIGS. 1 and 5 are not necessarily all the channels or carriers that may be utilized between a network node 108 and UE 106, and those of ordinary skill in the art will recognize that other channels or carriers may be utilized in addition to those illustrated, such as other traffic, control, and feedback channels.

In some examples, a physical layer may generally multiplex and map these physical channels described above to transport channels for handling at a medium access control (MAC) layer entity. Transport channels carry blocks of information called transport blocks (TB). The transport block size (TBS), which may correspond to a number of bits of information, may be a controlled parameter, based on the modulation and coding scheme (MCS) and the number of RBs in a given transmission.

Initial Access Procedure

UE 106 may perform a given initial access procedure to gain access to a cell and establish a radio resource control (RRC) connection with a RAN. This initial access procedure may include a cell search procedure, a random access procedure, and an RRC connection establishment procedure.

To perform a cell search, UE 106 monitors certain established resources known to carry synchronization signal/PBCH blocks (SS blocks). Once obtained, UE 106 may be configured to use the synchronization signals to synchronize with network node 108 and find its Cell ID, and use information in the PBCH to locate and acquire system information (SI) characterizing the cell. The RAN may provide this system information by periodically broadcasting the SS block and system information blocks (SIB s). That is, UE 106 may obtain a master information block (MIB) from the PBCH carried on the SS block, and a system information block type 1 (SIB1) from an identified data channel. Together, the MIB and SIB1 provide UE 106 with minimum system information (MSI) for cell access. UE 106 can acquire certain other system information (OSI) from further SIB s that the RAN may broadcast periodically or send on-demand. OSI may include any SI that is not broadcast in the MSI. In some examples, the PDSCH may carry a plurality of SIBs, not limited to SIB1, discussed above. Here, the RAN may provide the OSI in these SIBs, e.g., SIB2 and above.

These operations provide UE 106 with sufficient RRC information to identify the resources of a cell. However, to establish an RRC connection with the network node (e.g., network node 108), UE 106 may perform a random access procedure. Here, UE 106 and network node 108 exchange information with one another and establish an RRC connection. Ongoing connection management, for controlling a connectivity status of UE 106 with the core network, may be handled by way of higher-layer signaling protocols (e.g., RRC).

Mobility

In a radio access network, the ability for a UE to communicate while moving, independent of its location, is referred to as mobility. An access and mobility management function (AMF, not illustrated, part of the core network 102 in FIG. 1) may generally set up, maintain, and release the various physical channels between UE 106 and the radio access network. The AMF may further include a security context management function (SCMF) that manages the security context for both the control plane and the user plane functionality, and a security anchor function (SEAF) that performs authentication.

Inter-Cell Mobility

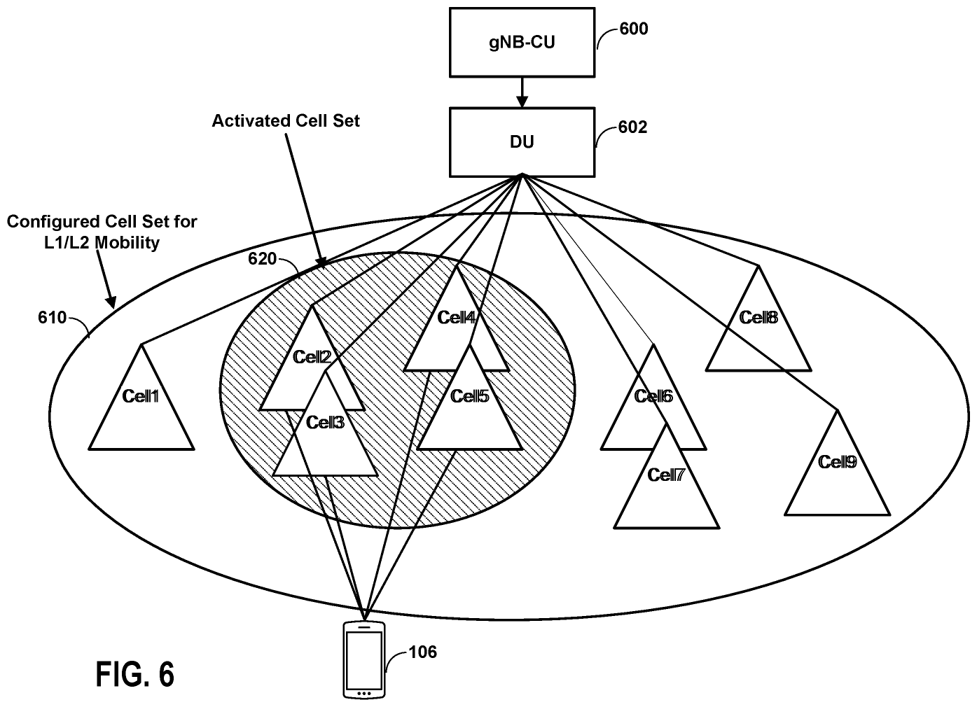

FIG. 6 is a schematic illustration of inter-cell mobility in accordance with various aspects of the present disclosure. In particular, FIG. 6 shows an example of L1/L2 inter-cell mobility. In L1/L2 inter-cell mobility, a network node, such as gNB-CU 600 and DU 602, may update a serving cell over which UE 106 may communicate, with the network node using L1 and/or L2 signaling. L1 signaling may include a DCI signal and L2 signaling may include a media access control (MAC) control element (CE) signal. The network node may send the L1/L2 signaling to UE 106 through the current serving cell (e.g., a special cell (SpCell). L1/L2 inter-cell mobility may be contrasted with other forms of inter-cell mobility, where serving cells may be updated using L3 RRC signaling.

In the example of FIG. 6, UE 106 may be configured to communicate with gNB-CU 600 and DU 600 through one or more cells (cell1-cell9) in configured cell set 610. In this example, gNB-CU 600 and DU 610 may be considered as one example of network node 108 in FIG. 1 in an Open RAN configuration. However, the techniques of this disclosure are not limited to an specific type of network node or type of network configuration. In the context of this disclosure, the term cell is generic term, and may be considered a radio unit (RU) in an Open RAN architecture. In other contexts, a cell may be a radio head, a Tx/Rx point (TRP), or a physical cell ID (PCI). In some examples, the cells in configured cell set 610 may be the same cell on different frequencies.

In one example of the disclosure, gNB-CU 600 and/or DU 602 may configure a set of cells (e.g., cell1-cell9) that support L1/L2 mobility through RRC signaling to UE 106. In this example, the cells that support L1/L2 mobility are configured cell set 610. The cells in configured cell set 610 are configured to have an SpCell (special cell) configuration. An SpCell is a combination of a primary cell (PCell) and a primary second cell (PSCell). A PCell may be used in an master cell group (MCG) and a PSCell is used in a secondary cell group (SCG). MCGs and SCGs are concepts used in dual connectivity and/or multi connectivity, where a UE may be connected to two or more network nodes. An MCG includes a group of serving cells associated with a Master Node, The SCG may include a group of serving cells associated with a Secondary Node. A PCell is used to initiate initial access to a network node in an MCG. A PSCell is used to perform initial access under an SCG. The SpCell performs the functions of both a PCell and a PSCell. The SpCell may support physical uplink control channel (PUCCH) transmission and contention-based random access and may also be activated. The cells in configured cell set 610 may be on the same carrier frequency or on different carrier frequencies. As such, the techniques of this disclosure are applicable for use with inter-cell carrier aggregation or intra-cell carrier aggregation.

Configured cell set 610 may include activated cell set 620 as well as a deactivated cell set. The deactivated cell set are the cells of configured cell set 610 that are not in activated cell set 620. In the example of FIG. 6, cell2, cell3, cell4, and cell 5 are in activated cell set 620. Therefore, cell1, cell6, cell7, cell8, and cell9 are in the deactivated cell set of configured cell set 610. The cells within activated cell set 620 can be used for data and/or control transmissions and SpCell update via L1/L2 signaling. That is, UE 106 and DU 602 may communicate data and control information through the cells in activated cell set 620. A special case of this scenario is when UE 106 is configured to have (e.g. based on the capability of UE 106) only one cell in activated cell set 620. In this case, the activation of another cell from configured cell set 610 would result in the deactivation of the current serving cell and an change in the SpCell.

The deactivated cell set are a group of cells in the L1/L2 mobility configured set 610 that cannot be used for data and control transmission and reception, but can be activated and used for SpCell update via L1/L2 signaling. In addition, UE 106 may be configured to perform L1 signal measurements on the cells in the deactivated cell set as well as the cells in activated cell set 620. UE 106 would report any L1 signal measurements on the cells in the deactivated cell set via one or more cells in activated cell set 620.

As described above, for L1/L2 inter-cell mobility, deactivated cells in configured cell set 610 can support L1 signal measurements. UE 106 may perform the L1 signal measurements and report such measurements to DU 602 in order to facilitate sufficient beam management, timing synchronization, power control, and SpCell functionality activation. UE may 106 be configured to send the report to DU 602 via a DCI signal (e.g., L1 signaling) or through a MAC CE signal (e.g., L2 signaling). When an L1/L2 mobility cell is in the deactivated cell set, UE 106 performs L1 signal measurement reporting for such a cell an activated cell in activated cell set 610. In some example techniques, which deactivated cells configured for L1/L2 mobility on which UE 106 performs L1 signal measurement reporting, as well as a type of reporting configuration to use, is determined by signaling from gNB-CU 600 and DU 602. For example, measurement and reporting is configured by gNB-CU 600/DU 602 and aperiodic measurement and reporting may be triggered by signaling from gNB-CU 600/DU 602.

Using direct signaling from a network node to instruct a UE to make L1 signal measurements for cells for L1/L2 mobility may not allow for fast SpCell update in all scenarios. This is because actions by the UE (e.g., mobility) as well as changes in channel conditions may be more quickly detected by the UE than the network node. This disclosure describes techniques wherein the UE is configured to trigger and report L1 signal measurements on cells in a configured cell set for L1/L2 mobility.

Measurement Reporting

As described above, a network node may use L1 signal measurements of the cells in a configured cell set to perform an L1/L2 mobility processes, such as update the SpCell and/or updating the cells that are in the activated cell set. A UE may be configured to perform L1 signal measurements on a plurality of cells in the configured cell set including both cells in the activated cell set and cells in the deactivated cell set.

In one example, the network node may configure the UE to perform L1 signal measurements through an RRC configuration. The L1 signal measurements may include an L1 signal to interference and noise ratio (L1-SINR) measurement and/or an L1 reference signal received power (L1-RSRP) measurement. In any of the examples below, UE 106 may be configured to perform an SINR, RSRP, or other signal measurement on a CSI-RS or an synchronization signal block (SSB) reference signal. The UE may calculate an SINR measurement as an average over the power contribution of the resource elements carrying the measured signal divided by the average of the noise and interference power contribution over the resource elements carrying the measured signal within the same frequency bandwidth. The UE may calculate the RSRP measurement as an average over the power contributions of the resource elements that carry the measured signal.

The network node may also configure time and frequency of how the UE is to report the L1 signal measurements through an RRC configuration. In some examples, the reporting of the L1 signal measurements may be periodic (e.g., transmitted on PUCCH). In other examples, the reporting of the L1 signal measurements may be semi-persistent (e.g., in response to an activation command for transmission on PUCCH and/or DCI triggered for transmission on PUSCH). In other examples, the reporting of the L1 signal measurements may be aperiodic (e.g., DCI triggered and transmitted on PUSCH). In some examples, the network node may configure the UE to send the report via a DCI signal (e.g., L1 signaling) or through a MAC CE signal (e.g., L2 signaling).

In addition to the time and frequency of the reports, the network node may also configure L1 signal measurement reporting formats through an RRC configuration. Example reporting formats may include per cell reporting, where an L1 signal measurements is reported for each cell (e.g., as indicated by a cell ID). The network node may further enable L1 signal measurement reporting for deactivated cell. In another example, the network node may configure the UE to report L1 signal measurements per group of serving cells, including activated cells, deactivated cells, candidate cells, or a combination of activated, deactivated and candidate cells. In some examples, the network node may configured to the UE to send L1 signal measurement reports on a serving cell and additional PCI(s) (“AdditionalPCI”). In this context, the AdditionalPCI refers to the cell additional to the serving cell, where the serving and additional cell are on the same carrier frequency.

UE-Triggered L1 Signal Measurement

Returning to FIG. 6, on accordance with the techniques of this disclosure, UE 106 may be configured with one or more conditions that allow the UE to trigger L1 signal measurements of the cells in the configured cell set without direct instruction from a network node (e.g., gNB-CU 600/DU 602). The conditions that trigger the cell signal measurements may include or more of UE mobility condition, a channel strength measurement condition, and/or a predicted block condition. The network node may preconfigure UE 106 with the conditions that trigger the cell signal measurements. In addition, the network node may preconfigure to UE 106 with one or more reporting configurations that indicate a reporting format for reporting the L1 signal measurements. UE 106 may determine a specific reporting configuration based on one or more conditions, which may be the same as the conditions used to trigger the L1 signal measurements or may be different conditions. The network node may also preconfigure the resources (e.g., time, frequency, beam, etc.) over which the UE will transmit reports of the UE-triggered L1 signal measurements.

By preconfiguring UE 106 with conditions to trigger and report L1 signal measurements, the network node may receive such L1 signal measurements in a timelier fashion compared to techniques where the network node explicitly requests the L1 signal measurements. As such, the techniques of this disclosure may facilitate faster serving cell updates (e.g., SpCell updates) for L1/L2 inter-cell mobility, as well as may facilitate faster beam management, timing synchronization, and power control.

In one general example of the disclosure, UE 106 may be configured to determine that a first condition (e.g., out of a plurality of conditions) is triggered for performing one or more L1 signal measurements for inter-cell mobility, perform the one or more L1 signal measurements of one or more cells in a configured cell set (e.g., configured cell set 610 of FIG. 6) for UE 106 based on determining that the first condition is triggered, and send a report of the one or more L1 signal measurements to a network node (e.g., network node 108 of FIG. 1 and/or gNB-CU600/DU602 of FIG. 6). In a reciprocal fashion, a network node (e.g., network node 108 of FIG. 1 and/or gNB-CU600/DU602 of FIG. 6) may send, to UE 106, one or more conditions for triggering one or more L1 signal measurements of one or more cells in a configured cell set for UE 106 for inter-cell mobility, receive, from UE 106, a report of the one or more L1 signal measurements, and perform an inter-cell mobility operation based on the one or more L1 signal measurements. In some examples of the disclosure, performing an inter-cell mobility operation may include one or more of updating a serving cell (e.g., an SpCell) in activated cell set of the configured cell set and/or designating particular cells in the configured cell set as being in the activated cell set. Examples of the disclosure for configuring the conditions for UE-triggered L1 signal measurements, configuring reporting configurations for reporting the L1 signal measurements, configuring resources for reporting the L1 signal measurements, and configuring filtering techniques for the L1 signal measurements are described in more detail below.

As described above, UE 106 may be preconfigured via RRC signaling with one or more conditions for triggering L1 signal measurements of the cells in configured cell set 610. That is, UE 106 may receive, from the network node, one or more conditions for triggering one or more L1 signal measurements. Likewise, a network node (e.g., network node 108 of FIG. 1 and/or gNB-CU600/DU602 of FIG. 6), may be configured to send the one or more conditions to UE 106 via RRC signaling.

In one example of the disclosure, a condition for UE-triggered L1 signal measurements is a mobility condition. In general, the UE mobility condition is a movement distance threshold. The movement distance threshold may be in terms of distance, speed, acceleration, or any combination thereof. UE 106 may use one or more sensors and/or data available to UE 106 to determine distance, speed, and/or acceleration of the UE. Such sensors may include global positioning system (GPS) sensors, other position-location sensors, accelerometers, and the like. UE 106 may be configured to determine a movement distance of the UE, and compare the movement distance to the movement distance threshold of the mobility condition to generate a comparison. UE 106 may then determine, based on the comparison, that the UE mobility condition is triggered for performing the one or more L1 signal measurements for inter cell mobility. If triggered, UE 106 may calculate the L1 signal measurements and report the L1 signal measurements to the network node. Movement of the UE may cause deterioration of channel quality on one or more cells in the configured cell set. By triggering L1 signal measurements based on a UE mobility condition, faster L1 signal measurements may be achieved, thus allowing for faster update of the serving cell and/or faster update of the cells in the activated cell set.

In another example, the condition for UE-triggered L1 signal measurements is a channel strength measurement condition. The channel strength measurement condition is a channel strength threshold of one or more cells in the configured cell set. The channel strength measurement may be a power level of signal strength of a particular reference signal, such as a PSS, an SSS, a DM-RS, a PT-RS, a CSI-RS, or another signal. The channel strength measurement condition may apply to certain preselected cells or all cells from the L1/L2 mobility cell set. In one example, UE 106 may be configured to determine a channel strength of at least one cell of the one or more cells in the configured cell set. UE 106 may compare the channel strength to the channel strength threshold to generate a comparison. UE 106 may then determine, based on the comparison, that the channel strength measurement condition is triggered for performing the one or more L1 signal measurements for inter cell mobility. A loss of channel strength on a particular cell or cells detected by UE 106 may be indicative of a need for a change in the serving cell (e.g., SpCell) and/or an update of deactivated cells in the activated cell set. By having UE 106 trigger L1 signal measurements based on a channel strength measurement, faster L1 signal measurements may be achieved, thus allowing for faster update of the serving cell and/or faster update of the cells in the activated cell set.

In another example, the condition for UE-triggered L1 signal measurements is a predicted blocking condition. In this example, UE 106 may be configured to perform a predictive blocking process to determine a predicted blocking value. In this context, a predicted blocking process may be any process performed by UE 106 that is configured to determine changes in the physical environment around UE 106 that will or is predicted to deteriorate the channel quality on one or more cells. For example, UE 106 may perform a predicted blocking process determine if buildings, automobiles, persons, or other objects may cause a degradation or deterioration of the signal of one or more cells of the activated cell set. UE 106 may use cameras, LiDAR, radar, or other sensor technologies to perform the predicted blocking process. In other examples, the predicted blocking may be based on maximum permissible exposure (MPE) restrictions, where the power density of a transmitting antenna of the UE may be reduced based on proximity to a user. Regardless of how the predicted blocking is performed and how the predicted blocking value is determined, UE 1906 may compare the predicted blocking value to the predicted blocking condition to generate a comparison, and determine, based on the comparison, that the predicted blocking condition is triggered for performing the one or more L1 signal measurements for inter cell mobility. Predicted blocking of the signal between a particular cell or cells communicating with the UE 106 may be indicative of a need for a change in the serving cell (e.g., SpCell) and/or an update of deactivated cells in the activated cell set. By having UE 106 trigger L1 signal measurements based on the predicted blocking, faster L1 signal measurements may be achieved, thus allowing for faster update of the serving cell and/or faster update of the cells in the activated cell set.

In addition the conditions described above, the network node may configure UE 106 with other conditions that are detectable by the UE that may be indicative of a change in channel conditions that may warrant L1 signal measurements. Furthermore, UE 106 is not limited to triggering the L1 signal measurements based on a single condition, but may trigger L1 signal measurements based on any combination of conditions that are configured.

In addition to preconfiguring the conditions on which UE 106 may trigger L1 signal measurements, the network node may further configure UE 106, e.g., via an RRC configuration, which cell or cells of configured cell set 610 to perform the L1 signal measurements on. Multiple cell groups may be configured. In one example, UE 106 may receive, from the network node, a measurement configuration that includes one or more measurement parameters for performing the one or more L1 signal measurements, and perform, based on the one or more measurement parameters, the one or more L1 signal measurements of the one or more cells in the configured cell set. The measurement configuration may be separate from the configuration of the conditions that trigger the L1 signal measurements, or may be included in the same RRC configuration as the conditions. In one example, the one or more measurement parameters indicate one or more specific cells of the one or more cells in the configured cell set for which the one or more L1 signal measurements is to be performed.

In any of the above examples, the one or more L1 signal measurements performed by UE 106 may include one of a reference signal received power (RSRP) measurement or a signal-to-noise and interference ratio (SINR) measurement. However, other types of L1 signal measurements may be performed. In one example, UE 106 may be configured to perform the one or more L1 signal measurements of one or more cells in an activated cell set of the configured cell set. In another example, UE 106 may be configured to perform the one or more L1 signal measurements of one or more cells in a deactivated cell set of the configured cell set. In still another example, UE 106 may be configured to perform the one or more L1 signal measurements of one or more cells in the activated cell set of the configured cell set and perform the one or more L1 signal measurements of one or more cells in the deactivated cell set of the configured cell set.

After sending the L1 measurements to the network node, UE 106 may receive, from the network node, an L1 signaling or a L2 signaling that indicates an updated serving cell in an activated cell set based on the L1 signal measurements. In one example, the L1 signaling is downlink control information (DCI) signaling, the L2 signaling is media access control (MAC) control element (CE) signaling, and the serving cell is a special cell (SpCell).

UE-Triggered L1 Signal Measurement Reporting

Once triggering condition is met, UE 106 may report multiple measurements to the network node. UE 106 may be configured to report the L1 signal measurements (e.g., SINR or RSRP) per cell id that was measured. Just like preconfiguring the conditions on which to trigger the L1 signal measurements, the network node may also configured to manner in which UE 106 is to send the report of the L1 signal measurements. For example, the network node may configure the duration of UE 106 sending the report. The network node may also configure the number of reports sent during the reporting period. If multiple reports are sent, the network node may further configure the periodicity of reporting. In some examples, the network node may also configure UE may 106 to send the report via a DCI signal (e.g., L1 signaling) or through a MAC CE signal (e.g., L2 signaling).

The network node may provide different reporting configurations to UE 106. In addition, the network node may provide one or more thresholds that UE 106 may be used to determine which reporting configuration to use (e.g., determine the active reporting configuration). The thresholds for the reporting configurations may the same as those used for triggering the L1 signal measurements or may be different thresholds. Some example thresholds for determining a reporting configuration may include a UE movement threshold and/or a channel strength threshold. For example, if UE 106 determines that the UE has moved more than x meters, UE 106 may use reporting configuration A. If UE 106 determines that a channel strength on a particular cells drops more than y dB, UE 106 may use reporting configuration B. In other example, the network node may signal an explicit indication (e.g., using MAC CE or DCI) that indicates to UE 106 which reporting configuration to use. In other examples, UE 106 may be configured to determine the reporting configuration based on a combination of thresholds and/or explicit signaling from the network node.

Accordingly, in one example of the disclosure, UE 106 may be configured to receive, from the network node, a reporting configuration that includes reporting parameters for reporting the one or more L1 signal measurements, and send, based on the reporting parameters, the report of the one or more L1 signal measurements to the network node. In one example, the reporting parameters indicate one or more of a duration of the report, a number of reports, or a periodicity of multiple reports.

In another example, UE 106 is configured to receive a plurality of configurations, wherein each configuration of the plurality of configurations includes one or more of measurement parameters for performing one or more L1 signal measurements or reporting parameters for reporting the one or more L1 signal measurements. UE 106 may determine an active configuration from the plurality of configurations, and operate according to the active configuration. In one example, to determine the active configuration from the plurality of configurations, UE 106 is configured to determine the active configuration from the plurality of configurations based on one or more of a UE mobility condition or a channel strength measurement. In another example, to determine the active configuration from the plurality of configurations, UE 106 is configured to receive a configuration signal from the network node that indicates the active configuration from the plurality of configurations. In one example, the configuration signal is one or more of a DCI signal or a MAC CE) signal.

The reporting parameters and configurations may be separate from the configuration of the conditions that trigger the L1 signal measurements or the measurement configuration, or may be included in the same RRC configuration as the conditions and measurements configuration.

UE-Triggered L1 Signal Measurement Reporting Resources

The network node may also configure (e.g., via RRC signaling) the resources on which UE 106 is to send the L1 signal measurement report. The networking node may preconfigure UE 106 with the resources to use at initial access or any RRC reconfiguration. The resources over which UE 106 may transmit the L1 signal measurement report may be in terms of time, frequency, or space (e.g. beam) domains. The network node may preconfigure the UE with multiple resources, and each of the resources may be associated with a particular reporting configurations described above. In some examples, each reporting configuration may be associated with multiple resources. UE 106 may also be configured to couple the UE-triggered L1 signal measurements and reports with existing periodic L1 reporting. In other examples, the network node may provide UE 106 with an on-demand, dynamic grant of resources (e.g., not preconfigured) via a DCI scheduling uplink transmission.

In one example, UE 106 may receive, from the network node, a resource configuration that includes one or more resource parameters for reporting the one or more L1 signal measurements, wherein the one or more resource parameters indicate one or more resource, and send, based on the resource parameters, the report of the one or more L1 signal measurements to the network node. In one example, the one or more resource parameters include one or more of a time, a frequency, or a beam on which to send the report. In one example, UE 106 may receive the resource configuration that includes the one or more resource parameters from the network node via RRC signaling.

In another example, UE 106 may receive, from the network node, a dynamic grant of resources to use for reporting the one or more L1 signal measurements, and send, based on the dynamic grant of resources, the report of the one or more L1 signal measurements to the network node. In one example, UE 106 may receive, from the network node, the dynamic grant of resources via DCI signaling.

UE-Triggered L1 Signal Measurement Reporting Filtering

UE 106 may not only be configured to calculate L1 signal measurements; in some examples, UE 106 may be configured to filter the L1 signal measurements in order to smooth out jitteriness, noise, or random error in the measurements. In some examples, UE 106 may send the L1 signal measurements to the network node without filtering and the network node may perform the filtering.

In one example, UE 106 and/or network node may perform a weighted filter, such as an infinite impulse response (IIR) filter to an L1 signal measurement. One example filtering algorithm is shown below:

M(t)=a*M(t−1)+(1−a)*B(t), for t=0,1,2, . . .

In this example, M(t) is the reported L1 signal measurement at time t, M(t−1) is the previously reported L1 signal measurement at time t−1, and B(t) is the currently calculated L1 signal measurement at time t, and variable a is a weight (e.g., a weight with a value that is less than or equal to 1). As can be seen in the above equation, the reported L1 signal measurement at time t (M(t)) is a linearly weighted combination of the current measurement and the previously reported measurement.

The network node may preconfigure UE 106 with a filtering scheme to apply when triggering multiple measurements and reporting. The network node may preconfigure UE 106 with a filter model and filtering parameters (e.g., filter coefficients and weights). The network node may also preconfigure UE 106 with multiple filtering schemes which may be configured and switched using MAC-CE or DCI signaling.

In one example, UE 106 may be configured to filter the one or more L1 signal measurements prior to sending the report. In this example, UE 106 may receive, from the network node, a filtering configuration that includes filtering parameters for filtering the one or more L1 signal measurements, and filter, based on the filtering parameters, the one or more L1 signal measurements prior to sending the report. The filtering parameters may include one or more of filter coefficients or a filter model. UE 106 may receive the filtering configuration that includes filtering parameters in one or more of a DCI signal or a MAC-CE signal.

RRC Configuration of UE-Triggered L1 Signal Measurements

As discussed above, the network node may use RRC signaling to configure UE 106 with any of the following parameters:
UE triggered measurement and reporting triggering conditions
The number of reports once triggered (duration and periodicity)
Reporting resource utilization options
Filtering strategies and related parameters

Multiple parameters may be configured or reconfigured by RRC and the network node may use MAC-CE or DCI to switch the configurations. In some examples, prior to configuring UE 106 with any of the above parameters, UE 106 may be configured to signal capability information to the network node. The capability information may indicate the UEs capabilities with regard to L1 signal measurements, predicted blocking techniques, filtering capabilities, or other constraints that the UE may have. For example, the capabilities may indicate how many L1 signal measurements the UE is capable of performing over a particular period of time. The capability information may indicate any predicted blocking techniques the UE is capable of performing. The network node may use the capability information to determine one or of the parameters described above and preconfigure the UE appropriately.

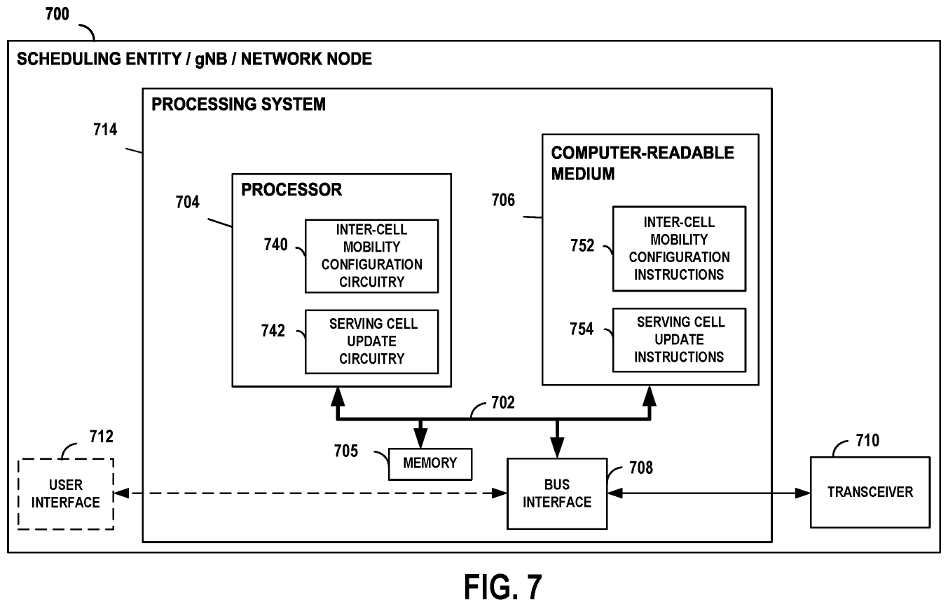

FIG. 7 is a block diagram illustrating an example of a hardware implementation for a network node 700 employing a processing system 714. For example, the network node 700 may be a base station and/or gNB, gNB-CU, DU, or other network nodes as illustrated in any one or more of FIGS. 1, 2, 3 and/or 6.

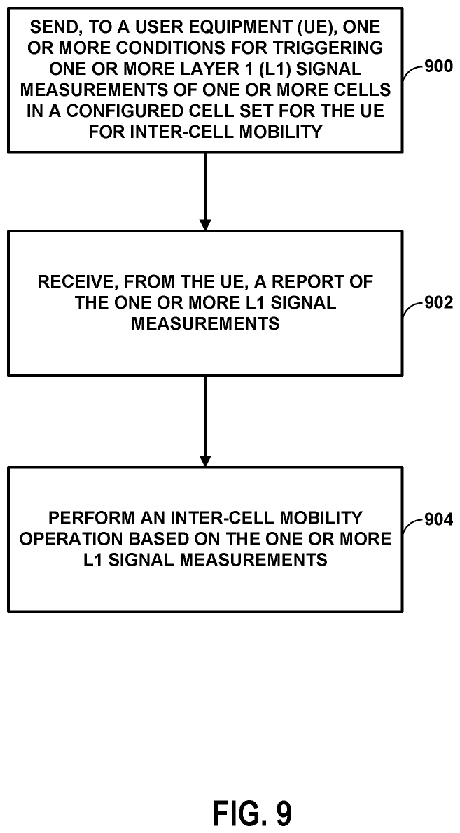

The network node 700 may include a processing system 714 having one or more processors 704. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network node 700 may be configured to perform any one or more of the functions described herein. For example, the processor 704, as utilized in a network node 700, may be configured (e.g., in coordination with the memory 705) to implement any one or more of the processes and procedures for UE-triggered L1 measurements for L1/L2 inter-cell mobility described above and further illustrated in FIG. 9.

The processing system 714 may be implemented with a bus architecture, represented generally by the bus 702. The bus 702 may include any number of interconnecting buses and bridges depending on the specific application of the processing system 714 and the overall design constraints. The bus 702 communicatively couples together various circuits including one or more processors (represented generally by the processor 704), a memory 705, and computer-readable media (represented generally by the computer-readable medium 706). The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a communication interface or means for communicating with various other apparatus over a transmission medium. Depending upon the nature of the apparatus, a user interface 712 (e.g., keypad, display, speaker, microphone, joystick) may also be provided. Of course, such a user interface 712 is optional, and some examples, such as a base station, may omit it.

In some aspects of the disclosure, the processor 704 may include inter-cell mobility configuration circuitry 740 configured (e.g., in coordination with the memory 705) for various functions, including, e.g., sending, to a UE, one or more conditions for triggering one or more L1 signal measurements of one or more cells in a configured cell set for the UE for inter cell mobility, in accordance with any of the techniques described above. In addition to conditions for triggering L1 signal measurements, inter-cell mobility configuration circuitry 740 may also be configured to configure a reporting configuration for the L1 signal measurements, configure a resource allocation for the reporting the L1 signal measurements, and/or configure parameters for filtering the L1 signal measurements according to any combination of techniques described above.

Processor 704 may further include serving cell update circuitry 742 configured (e.g., in coordination with the memory 705) for various functions, including, e.g., configured receiving, from the UE, a report of the one or more L1 signal measurements, and performing an inter cell mobility operation based on the one or more L1 signal measurements, and performing an inter cell mobility operation based on the one or more L1 signal measurements, such as updating a serving cell (e.g., SpCell) and/or updating the cells in an activated cell set, according to any combination of techniques described above.

The processor 704 is responsible for managing the bus 702 and general processing, including the execution of software stored on the computer-readable medium 706. The software, when executed by the processor 704, causes the processing system 714 to perform the various functions described below for any particular apparatus. The processor 704 may also use the computer-readable medium 706 and the memory 705 for storing data that the processor 704 manipulates when executing software.

One or more processors 704 in the processing system may execute software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706. The computer-readable medium 706 may be a non-transitory computer-readable medium. One or more non-transitory computer-readable media includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 706 may reside in the processing system 714, external to the processing system 714, or distributed across multiple entities including the processing system 714. The computer-readable medium 706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 706 may store computer-executable code that includes inter-cell mobility configuration instructions 752 that configure a network node 700 for various functions, including, e.g., sending, to a UE, one or more conditions for triggering one or more L1 signal measurements of one or more cells in a configured cell set for the UE for inter cell mobility, in accordance with any of the techniques described above. In addition to conditions for triggering L1 signal measurements, inter-cell mobility configuration instructions 752 may also be configured to configure a reporting configuration for the L1 signal measurements, configure a resource allocation for the reporting the L1 signal measurements, and/or configure parameters for filtering the L1 signal measurements according to any combination of techniques described above.

Computer-readable medium 706 may further include serving cell update instructions 754 that may cause network node 700 to receive, from a UE, a report of the one or more L1 signal measurements, and performing an inter cell mobility operation based on the one or more L1 signal measurements, and perform an inter cell mobility operation based on the one or more L1 signal measurements, such as updating a serving cell (e.g., SpCell) and/or updating the cells in an activated cell set, according, according to any combination of techniques described above.

In one configuration, an apparatus for wireless communication includes means for performing the techniques of this disclosure. In one aspect, the aforementioned means may be the processor(s) 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the FIGS. 1, 2, 3, and/or 6, and utilizing, for example, the processes and/or algorithms described herein in relation to FIG. 9.

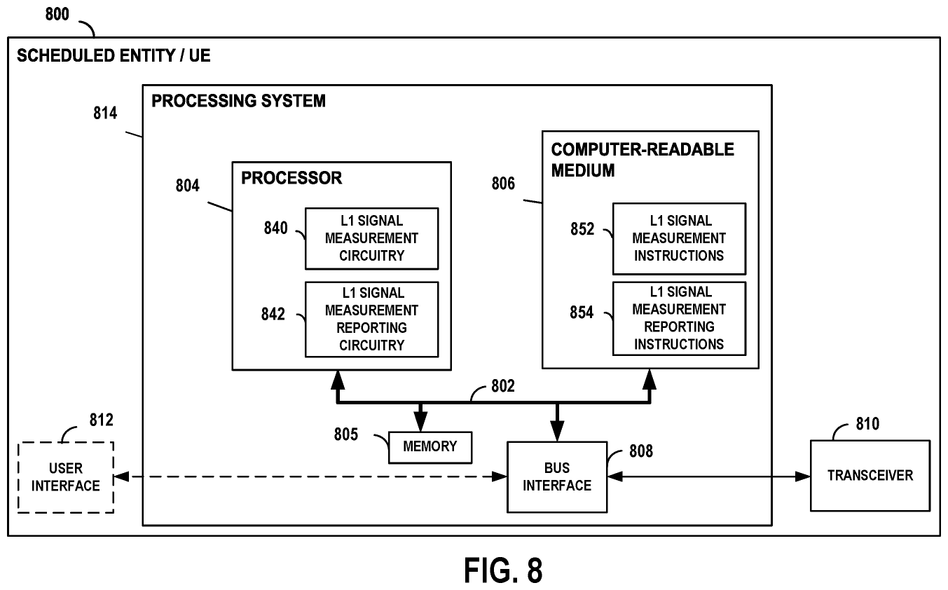

FIG. 8 is a conceptual diagram illustrating an example of a hardware implementation for an exemplary UE 800 employing a processing system 814. In accordance with various aspects of the disclosure, a processing system 814 may include an element, or any portion of an element, or any combination of elements having one or more processors 804. For example, the UE 800 may be a UE as illustrated in any one or more of FIGS. 1, 2, 3, and/or 6.

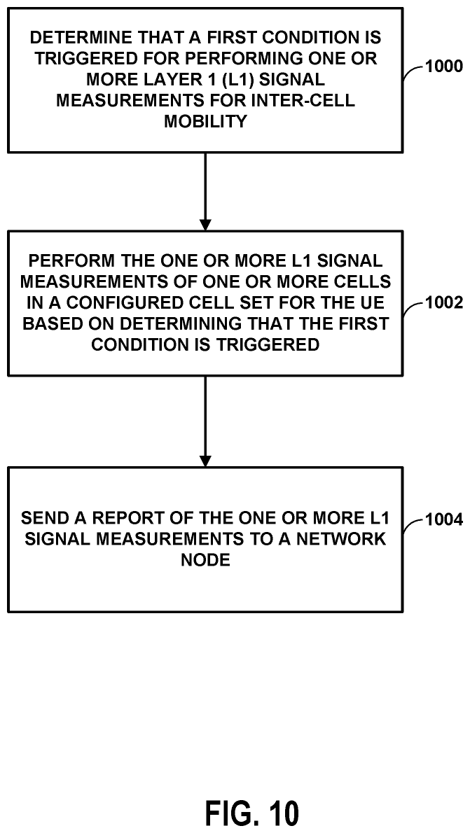

The processing system 814 may be substantially the same as the processing system 714 illustrated in FIG. 7, including a bus interface 808, a bus 802, memory 805, a processor 804, and a computer-readable medium 806. Furthermore, the UE 800 may include a user interface 812 and a transceiver 810 substantially similar to those described above in FIG. 7. That is, the processor 804, as utilized in a UE 800, may be configured (e.g., in coordination with the memory 805) to implement any one or more of the processes described below and illustrated in FIG. 10.

In some aspects of the disclosure, the processor 804 may include L1 measurement circuitry 840 configured (e.g., in coordination with the memory 805) for various functions, including, for example, determining that a first condition is triggered for performing one or more L1 signal measurements for inter-cell mobility, and performing the one or more L1 signal measurements of one or more cells in a configured cell set for the UE based on determining that the first condition is triggered according to any combination of the examples described above. Processor 804 may further include L1 measurement reporting circuitry 842 configured to send a report of the one or more L1 signal measurements to a network node in accordance with any of the examples described above.

Computer-readable storage medium 806 may store computer-executable code that includes L1 measurement instructions 852 that configure a UE 800 for various functions, including, e.g., determining that a first condition is triggered for performing one or more L1 signal measurements for inter-cell mobility, and performing the one or more L1 signal measurements of one or more cells in a configured cell set for the UE based on determining that the first condition is triggered according to any combination of the examples described above. The computer-readable storage medium 806 may further include L1 signal measurement reporting instructions 854 that send a report of the one or more L1 signal measurements to a network node in accordance with any of the examples described above.

In one configuration, an apparatus for wireless communication includes means for performing the techniques of this disclosure. In one aspect, the aforementioned means may be the processor(s) 804 shown in FIG. 8 configured to perform the functions recited by the aforementioned means. In another aspect, the aforementioned means may be a circuit or any apparatus configured to perform the functions recited by the aforementioned means.

Of course, in the above examples, the circuitry included in the processor 804 is merely provided as an example, and other means for carrying out the described functions may be included within various aspects of the present disclosure, including but not limited to the instructions stored in the computer-readable storage medium 806, or any other suitable apparatus or means described in any one of the FIGS. 1, 2, 3, and/or 6, and utilizing, for example, the processes and/or algorithms described herein in relation to FIG. 10.

FIG. 9 is a flow chart illustrating an exemplary process for configuring a UE to perform UE-triggered L1 signal measurements for L1/L2 inter-cell mobility in accordance with some aspects of the present disclosure. As described below, a particular implementation may omit some or all illustrated features, and may not require some illustrated features to implement all examples. In some examples, the network node 700 illustrated in FIG. 7 may be configured to carry out the process of FIG. 9. In some examples, any suitable apparatus or means for carrying out the functions or algorithm described below may carry out the process of FIG. 9.

In one example, a network node, such as network node 700 of FIG. 7, may be configured to send, to a UE, one or more conditions for triggering one or L1 signal measurements of one or more cells in a configured cell set for the UE for inter-cell mobility (900). Network node 700 may receive, from the UE, a report of the one or more L1 signal measurements (902). Network node may then perform an inter-cell mobility operation based on the one or more L1 signal measurements (904). As discussed above, In some examples of the disclosure, performing an inter-cell mobility operation may include one or more of updating a serving cell (e.g., an SpCell) in activated cell set of the configured cell set and/or designating particular cells in the configured cell set as being in the activated cell set.

FIG. 10 is a flow chart illustrating an exemplary process for UE-triggered L1 signal measurements for L1/L2 inter-cell mobility in accordance with some aspects of the present disclosure. As described below, a particular implementation may omit some or all illustrated features, and may not require some illustrated features to implement all examples. In some examples, the UE 800 illustrated in FIG. 8 may be configured to carry out the process of FIG. 10. In some examples, any suitable apparatus or means for carrying out the functions or algorithm described below may carry out the process of FIG. 10.

In one example, UE 800 may be configured to determine that a first condition is triggered for performing one or more L1 signal measurements for inter-cell mobility (1000). UE 800 may perform the one or more L1 signal measurements of one or more cells in a configured cell set for the UE based on determining that the first condition is triggered (1002), and send a report of the one or more L1 signal measurements to a network node (1004).

The following numbered clauses illustrate one or more aspects of the devices and techniques described in this disclosure.

Aspect 1—A user equipment (UE) for wireless communication, the UE comprising: a memory; and a processor in communication with the memory, the processor configured to: determine that a first condition is triggered for performing one or more layer 1 (L1) signal measurements for inter-cell mobility; perform the one or more L1 signal measurements of one or more cells in a configured cell set for the UE based on determining that the first condition is triggered; and send a report of the one or more L1 signal measurements to a network node.

Aspect 2—The UE of Aspect 1, wherein the processor is further configured to: receive, from the network node, one or more conditions for triggering the one or more L1 signal measurements, wherein the one or more conditions includes the first condition.

Aspect 3—The UE of Aspect 2, wherein the processor is further configured to: receive, from the network node, the one or more conditions via radio resource control (RRC) signaling.

Aspect 4—The UE of Aspect 2, wherein the one or more conditions include one or more of a UE mobility condition, a channel strength measurement condition associated with the configured cell set, or a predicted blocking condition.

Aspect 5—The UE of Aspect 4, wherein the first condition is the UE mobility condition, wherein the UE mobility condition is a movement distance threshold of the UE, and wherein the processor is further configured to: determine a movement distance of the UE; compare the movement distance to the movement distance threshold to generate a comparison; and determine, based on the comparison, that the UE mobility condition is triggered for performing the one or more L1 signal measurements for inter-cell mobility.

Aspect 6—The UE of Aspect 4, wherein the first condition is the channel strength measurement condition, wherein the channel strength measurement condition is a channel strength threshold of one or more cells in the configured cell set, and wherein the processor is further configured to: determine a channel strength of at least one cell of the one or more cells in the configured cell set; compare the channel strength to the channel strength threshold to generate a comparison; and determine, based on the comparison, that the channel strength measurement condition is triggered for performing the one or more L1 signal measurements for inter-cell mobility.

Aspect 7—The UE of Aspect 4, wherein the first condition is the predicted blocking condition, and wherein the processor is further configured to: perform a predictive blocking process to determine a predicted blocking value; compare the predicted blocking value to the predicted blocking condition to generate a comparison; and determine, based on the comparison, that the predicted blocking condition is triggered for performing the one or more L1 signal measurements for inter-cell mobility.

Aspect 8—The UE of Aspect 1, wherein the processor is further configured to: receive, from the network node, a measurement configuration that includes one or more measurement parameters for performing the one or more L1 signal measurements; and perform, based on the one or more measurement parameters, the one or more L1 signal measurements of the one or more cells in the configured cell set.

Aspect 9—The UE of Aspect 8, wherein the one or more measurement parameters indicate one or more specific cells of the one or more cells in the configured cell set for which the one or more L1 signal measurements is to be performed.

Aspect 10—The UE of Aspect 1, wherein the processor is further configured to: receive, from the network node, a reporting configuration that includes reporting parameters for reporting the one or more L1 signal measurements; and send, based on the reporting parameters, the report of the one or more L1 signal measurements to the network node.

Aspect 11—The UE of Aspect 10, wherein the reporting parameters indicate one or more of a duration of the report, a number of reports, or a periodicity of multiple reports.

Aspect 12—The UE of Aspect 1, wherein the processor is further configured to: receive a plurality of configurations, wherein each configuration of the plurality of configurations includes one or more of measurement parameters for performing one or more L1 signal measurements or reporting parameters for reporting the one or more L1 signal measurements; determine an active configuration from the plurality of configurations; and operate according to the active configuration.

Aspect 13—The UE of Aspect 12, wherein to determine the active configuration from the plurality of configurations, the processor is configured to: determine the active configuration from the plurality of configurations based on one or more of a UE mobility condition or a channel strength measurement.

Aspect 14—The UE of Aspect 12, wherein to determine the active configuration from the plurality of configurations, the processor is configured to: receive a configuration signal from the network node that indicates the active configuration from the plurality of configurations.

Aspect 15—The UE of Aspect 14, wherein the configuration signal is one or more of a downlink control information (DCI) signal or a media access control (MAC) control element (CE) signal.

Aspect 16—The UE of Aspect 1, wherein the processor is further configured to: receive, from the network node, a resource configuration that includes one or more resource parameters for reporting the one or more L1 signal measurements, wherein the one or more resource parameters indicate one or more resources; and send, based on the resource parameters, the report of the one or more L1 signal measurements to the network node.

Aspect 17—The UE of Aspect 16, wherein the one or more resource parameters include one or more of a time, a frequency, or a beam on which to send the report.

Aspect 18—The UE of Aspect 16, wherein the processor is further configured to: receive the resource configuration that includes the one or more resource parameters from the network node via radio resource control (RRC) signaling.

Aspect 19—The UE of Aspect 1, wherein the processor is further configured to: receive, from the network node, a dynamic grant of resources to use for reporting the one or more L1 signal measurements; and send, based on the dynamic grant of resources, the report of the one or more L1 signal measurements to the network node.

Aspect 20—The UE of Aspect 19, wherein the processor is further configured to: receive, from the network node, the dynamic grant of resources via downlink control information (DCI) signaling.

Aspect 21—The UE of Aspect 1, wherein the processor is further configured to: filter the one or more L1 signal measurements prior to sending the report.

Aspect 22—The UE of Aspect 21, wherein the processor is further configured to: receive, from the network node, a filtering configuration that includes filtering parameters for filtering the one or more L1 signal measurements; and filter, based on the filtering parameters, the one or more L1 signal measurements prior to sending the report.

Aspect 23—The UE of Aspect 22, wherein the filtering parameters include one or more of filter coefficients or a filter model.

Aspect 24—The UE of Aspect 22, wherein the processor is further configured to:
receive the filtering configuration that includes filtering parameters in one or more of a downlink control information (DCI) signal or a media access control (MAC) control element (CE) signal.

Aspect 25—The UE of Aspect 1, wherein the one or more L1 signal measurements include one of a reference signal received power (RSRP) measurement or a signal-to-noise and interference ratio (SINR) measurement.

Aspect 26—The UE of Aspect 1, wherein to perform the one or more L1 signal measurements of the one or more cells in the configured cell set, the processor is configured to: perform the one or more L1 signal measurements of one or more cells in an activated cell set of the configured cell set; perform the one or more L1 signal measurements of one or more cells in a deactivated cell set of the configured cell set; or perform the one or more L1 signal measurements of one or more cells in the activated cell set of the configured cell set and perform the one or more L1 signal measurements of one or more cells in the deactivated cell set of the configured cell set.

Aspect 27—The UE of Aspect 1, wherein the processor is further configured to: receive, from the network node, an L1 signaling or a layer 2 (L2) signaling that indicates an updated serving cell in an activated cell set based on the L1 signal measurements.

Aspect 28—The UE of Aspect 27, wherein the L1 signaling is downlink control information (DCI) signaling, the L2 signaling is media access control (MAC) control element (CE) signaling, and the serving cell is a special cell (SpCell).

Aspect 29—A method for wireless communication, the method comprising: determining, at a user equipment (UE), that a first condition is triggered for performing one or more layer 1 (L1) signal measurements for inter-cell mobility; performing the one or more L1 signal measurements of one or more cells in a configured cell set for the UE based on determining that the first condition is triggered; and sending a report of the one or more L1 signal measurements to a network node.

Aspect 30—The method of Aspect 29, further comprising: receiving, from the network node, one or more conditions for triggering the one or more L1 signal measurements, wherein the one or more conditions includes the first condition.

Aspect 31—The method of Aspect 30, further comprising: receiving, from the network node, the one or more conditions via radio resource control (RRC) signaling.

Aspect 32—The method of Aspect 30, wherein the one or more conditions include one or more of a UE mobility condition, a channel strength measurement condition associated with the configured cell set, or a predicted blocking condition.

Aspect 33—The method of Aspect 32, wherein the first condition is the UE mobility condition, wherein the UE mobility condition is a movement distance threshold of the UE, and wherein the method further comprises: determining a movement distance of the UE; comparing the movement distance to the movement distance threshold to generate a comparison; and determining, based on the comparison, that the UE mobility condition is triggered for performing the one or more L1 signal measurements for inter-cell mobility.

Aspect 34—The method of Aspect 32, wherein the first condition is the channel strength measurement condition, wherein the channel strength measurement condition is a channel strength threshold of one or more cells in the configured cell set, and wherein the method further comprises: determining a channel strength of at least one cell of the one or more cells in the configured cell set; comparing the channel strength to the channel strength threshold to generate a comparison; and determining, based on the comparison, that the channel strength measurement condition is triggered for performing the one or more L1 signal measurements for inter-cell mobility.

Aspect 35—The method of Aspect 23, wherein the first condition is the predicted blocking condition, and wherein the method further comprises: performing a predictive blocking process to determine a predicted blocking value; comparing the predicted blocking value to the predicted blocking condition to generate a comparison; and determining, based on the comparison, that the predicted blocking condition is triggered for performing the one or more L1 signal measurements for inter-cell mobility.

Aspect 36—The method of Aspect 29, further comprising: receiving, from the network node, a measurement configuration that includes one or more measurement parameters for performing the one or more L1 signal measurements; and performing, based on the one or more measurement parameters, the one or more L1 signal measurements of the one or more cells in the configured cell set.

Aspect 37—The method of Aspect 36, wherein the one or more measurement parameters indicate one or more specific cells of the one or more cells in the configured cell set for which the one or more L1 signal measurements is to be performed.

Aspect 38—The method of Aspect 29, further comprising: receiving, from the network node, a reporting configuration that includes reporting parameters for reporting the one or more L1 signal measurements; and sending, based on the reporting parameters, the report of the one or more L1 signal measurements to the network node.

Aspect 39—The method of Aspect 38, wherein the reporting parameters indicate one or more of a duration of the report, a number of reports, or a periodicity of multiple reports.

Aspect 40—The method of Aspect 29, further comprising: receiving a plurality of configurations, wherein each configuration of the plurality of configurations includes one or more of measurement parameters for performing one or more L1 signal measurements or reporting parameters for reporting the one or more L1 signal measurements; determining an active configuration from the plurality of configurations; and operating according to the active configuration.

Aspect 41—The method of Aspect 40, wherein determining the active configuration from the plurality of configurations comprises: determining the active configuration from the plurality of configurations based on one or more of a UE mobility condition or a channel strength measurement.

Aspect 42—The method of Aspect 40, wherein determining the active configuration from the plurality of configurations comprises: receiving a configuration signal from the network node that indicates the active configuration from the plurality of configurations.

Aspect 43—The method of Aspect 42, wherein the configuration signal is one or more of a downlink control information (DCI) signal or a media access control (MAC) control element (CE) signal.

Aspect 44—The method of Aspect 29, further comprising: receiving, from the network node, a resource configuration that includes one or more resource parameters for reporting the one or more L1 signal measurements, wherein the one or more resource parameters indicate one or more resources; and sending, based on the resource parameters, the report of the one or more L1 signal measurements to the network node.

Aspect 45—The method of Aspect 44, wherein the one or more resource parameters include one or more of a time, a frequency, or a beam on which to send the report.

Aspect 46—The method of Aspect 44, further comprising: receiving the resource configuration that includes the one or more resource parameters from the network node via radio resource control (RRC) signaling.

Aspect 47—The method of Aspect 29, further comprising: receiving, from the network node, a dynamic grant of resources to use for reporting the one or more L1 signal measurements; and sending, based on the dynamic grant of resources, the report of the one or more L1 signal measurements to the network node.

Aspect 48—The method of Aspect 47, further comprising: receiving, from the network node, the dynamic grant of resources via downlink control information (DCI) signaling.

Aspect 49—The method of Aspect 29, further comprising: filtering the one or more L1 signal measurements prior to sending the report.

Aspect 50—The method of Aspect 49, further comprising: receiving, from the network node, a filtering configuration that includes filtering parameters for filtering the one or more L1 signal measurements; and filtering, based on the filtering parameters, the one or more L1 signal measurements prior to sending the report.

Aspect 51—The method of Aspect 50, wherein the filtering parameters include one or more of filter coefficients or a filter model.

Aspect 52—The method of Aspect 50, further comprising: receiving the filtering configuration that includes filtering parameters in one or more of a downlink control information (DCI) signal or a media access control (MAC) control element (CE) signal.

Aspect 53—The method of Aspect 29, wherein the one or more L1 signal measurements include one of a reference signal received power (RSRP) measurement or a signal-to-noise and interference ratio (SINR) measurement.

Aspect 54—The method of Aspect 29, wherein performing the one or more L1 signal measurements of the one or more cells in the configured cell set comprises: performing the one or more L1 signal measurements of one or more cells in an activated cell set of the configured cell set; performing the one or more L1 signal measurements of one or more cells in a deactivated cell set of the configured cell set; or performing the one or more L1 signal measurements of one or more cells in the activated cell set of the configured cell set and perform the one or more L1 signal measurements of one or more cells in the deactivated cell set of the configured cell set.

Aspect 55—The method of Aspect 29, further comprising:
receiving, from the network node, an L1 signaling or a layer 2 (L2) signaling that indicates an updated serving cell in an activated cell set based on the L1 signal measurements.

Aspect 56—The method of Aspect 55, wherein the L1 signaling is downlink control information (DCI) signaling, the L2 signaling is media access control (MAC) control element (CE) signaling, and the serving cell is a special cell (SpCell).

Aspect 57—An apparatus comprising means for performing the methods of Aspects 29-56.

Aspect 58—A non-transitory computer-readable storage medium storing instructions that, when executed, cause one or more processors to perform the methods of Aspects 29-56.

Aspect 59—A network node for wireless communication, the network node comprising: a memory; and a processor in communication with the memory, the processor configured to: send, to a user equipment (UE), one or more conditions for triggering one or more layer 1 (L1) signal measurements of one or more cells in a configured cell set for the UE for inter-cell mobility; receive, from the UE, a report of the one or more L1 signal measurements; and perform an inter-cell mobility operation based on the one or more L1 signal measurements.

Aspect 60—The network node of Aspect 59, wherein the processor is further configured to: send the one or more conditions via radio resource control (RRC) signaling.

Aspect 61—The network node of Aspect 59, wherein the one or more conditions include one or more of a UE mobility condition, a channel strength measurement condition associated with the configured cell set, or a predicted blocking condition.

Aspect 62—The network node of Aspect 59, wherein the processor is further configured to: send, to the UE, a measurement configuration that includes one or more measurement parameters for performing the one or more L1 signal measurements.

Aspect 63—The network node of Aspect 62, wherein the one or more measurement parameters indicate one or more specific cells of the one or more cells in the configured cell set for which the one or more L1 signal measurements is to be performed.

Aspect 64—The network node of Aspect 59, wherein the processor is further configured to: send, to the UE, a reporting configuration that includes reporting parameters for reporting the one or more L1 signal measurements.

Aspect 65—The network node of Aspect 64, wherein the reporting parameters indicate one or more of a duration of the report, a number of reports, or a periodicity of multiple reports.

Aspect 66—The network node of Aspect 59, wherein the processor is further configured to: send, to the UE, a plurality of configurations, wherein each configuration of the plurality of configurations includes one or more of measurement parameters for performing one or more L1 signal measurements or reporting parameters for reporting the one or more L1 signal measurements.

Aspect 67—The network node of Aspect 66, wherein the processor is configured to: send, to the UE, a configuration signal that indicates an active configuration from the plurality of configurations.

Aspect 68—The network node of Aspect 67, wherein the configuration signal is one or more of a downlink control information (DCI) signal or a media access control (MAC) control element (CE) signal.

Aspect 69—The network node of Aspect 59, wherein the processor is further configured to: send, to the UE, a resource configuration that includes one or more resource parameters for reporting the one or more L1 signal measurements, wherein the one or more resource parameters indicate one or more resources.

Aspect 70—The network node of Aspect 69, wherein the one or more resource parameters include one or more of a time, a frequency, or a beam on which to send the report.

Aspect 71—The network node of Aspect 69, wherein the processor is further configured to: send the resource configuration that includes the one or more resource parameters via radio resource control (RRC) signaling.

Aspect 72—The network node of Aspect 59, wherein the processor is further configured to: send, to the UE, a dynamic grant of resources to use for reporting the one or more L1 signal measurements.

Aspect 73—The network node of Aspect 72, wherein the processor is further configured to: send the dynamic grant of resources via downlink control information (DCI) signaling.

Aspect 74—The network node of Aspect 59, wherein the processor is further configured to: filter the one or more L1 signal measurements.

Aspect 75—The network node of Aspect 59, wherein the processor is further configured to: send, to the UE, a filtering configuration that includes filtering parameters for filtering the one or more L1 signal measurements.

Aspect 76—The network node of Aspect 75, wherein the filtering parameters include one or more of filter coefficients or a filter model.

Aspect 77—The network node of Aspect 75, wherein the processor is further configured to: send the filtering configuration that includes filtering parameters in one or more of a downlink control information (DCI) signal or a media access control (MAC) control element (CE) signal.

Aspect 78—The network node of Aspect 59, wherein the one or more L1 signal measurements include one of a reference signal received power (RSRP) measurement or a signal-to-noise and interference ratio (SINR) measurement.

Aspect 79—The network node of Aspect 59, wherein the one or more L1 signal measurements correspond to one or more cells in an activated cell set of the configured cell set, correspond to one or more cells in a deactivated cell set of the configured cell set, or correspond to one or more cells in the activated cell set of the configured cell set and one or more cells in the deactivated cell set of the configured cell set.

Aspect 80—The network node of Aspect 59, wherein the processor is further configured to: send, to the UE, an L1 signaling or a layer 2 (L2) signaling that indicates an updated serving cell in the activated cell set based on the L1 signal measurements.

Aspect 81—The network node of Aspect 80, wherein the L1 signaling is downlink control information (DCI) signaling, the L2 signaling is media access control (MAC) control element (CE) signaling, and the serving cell is a special cell (SpCell).

Aspect 82—A method for wireless communication, the method comprising: sending, to a user equipment (UE), one or more conditions for triggering one or more layer 1 (L1) signal measurements of one or more cells in a configured cell set for the UE for inter-cell mobility; receiving, from the UE, a report of the one or more L1 signal measurements; and performing an inter-cell mobility operation based on the one or more L1 signal measurements.

Aspect 83—The method of Aspect 82, further comprising: sending the one or more conditions via radio resource control (RRC) signaling.

Aspect 84—The method of Aspect 82, wherein the one or more conditions include one or more of a UE mobility condition, a channel strength measurement condition associated with the configured cell set, or a predicted blocking condition.

Aspect 85—The method of Aspect 82, further comprising: sending, to the UE, a measurement configuration that includes one or more measurement parameters for performing the one or more L1 signal measurements.

Aspect 86—The method of Aspect 85, wherein the one or more measurement parameters indicate one or more specific cells of the one or more cells in the configured cell set for which the one or more L1 signal measurements is to be performed.

Aspect 87—The method of Aspect 82, further comprising: sending, to the UE, a reporting configuration that includes reporting parameters for reporting the one or more L1 signal measurements.

Aspect 88—The method of Aspect 87, wherein the reporting parameters indicate one or more of a duration of the report, a number of reports, or a periodicity of multiple reports.

Aspect 89—The method of Aspect 82, further comprising: sending, to the UE, a plurality of configurations, wherein each configuration of the plurality of configurations includes one or more of measurement parameters for performing one or more L1 signal measurements or reporting parameters for reporting the one or more L1 signal measurements.

Aspect 90—The method of Aspect 89, further comprising: sending, to the UE, a configuration signal that indicates an active configuration from the plurality of configurations.

Aspect 91—The method of Aspect 90, wherein the configuration signal is one or more of a downlink control information (DCI) signal or a media access control (MAC) control element (CE) signal.

Aspect 92—The method of Aspect 82, further comprising: sending, to the UE, a resource configuration that includes one or more resource parameters for reporting the one or more L1 signal measurements, wherein the one or more resource parameters indicate one or more resources.

Aspect 93—The method of Aspect 92, wherein the one or more resource parameters include one or more of a time, a frequency, or a beam on which to send the report.

Aspect 94—The method of Aspect 92, further comprising: sending the resource configuration that includes the one or more resource parameters via radio resource control (RRC) signaling.

Aspect 95—The method of Aspect 82, further comprising: sending, to the UE, a dynamic grant of resources to use for reporting the one or more L1 signal measurements.

Aspect 96—The method of Aspect 95, further comprising: sending the dynamic grant of resources via downlink control information (DCI) signaling.

Aspect 97—The method of Aspect 82, further comprising: filtering the one or more L1 signal measurements.

Aspect 98—The method of Aspect 82, further comprising: sending, to the UE, a filtering configuration that includes filtering parameters for filtering the one or more L1 signal measurements.

Aspect 99—The method of Aspect 98, wherein the filtering parameters include one or more of filter coefficients or a filter model.

Aspect 100—The method of Aspect 98, further comprising: sending the filtering configuration that includes filtering parameters in one or more of a downlink control information (DCI) signal or a media access control (MAC) control element (CE) signal.

Aspect 101—The method of Aspect 82, wherein the one or more L1 signal measurements include one of a reference signal received power (RSRP) measurement or a signal-to-noise and interference ratio (SINR) measurement.

Aspect 102—The method of Aspect 82, wherein the one or more L1 signal measurements correspond to one or more cells in an activated cell set of the configured cell set, correspond to one or more cells in a deactivated cell set of the configured cell set, or correspond to one or more cells in the activated cell set of the configured cell set and one or more cells in the deactivated cell set of the configured cell set.

Aspect 103—The method of Aspect 82, further comprising: sending, to the UE, an L1 signaling or a layer 2 (L2) signaling that indicates an updated serving cell in the activated cell set based on the L1 signal measurements.

Aspect 104—The method of Aspect 103, wherein the L1 signaling is downlink control information (DCI) signaling, the L2 signaling is media access control (MAC) control element (CE) signaling, and the serving cell is a special cell (SpCell).

Aspect 105—An apparatus comprising means for performing the methods of Aspects 82-104.

Aspect 106—A non-transitory computer-readable storage medium storing instructions that, when executed, cause one or more processors to perform the methods of Aspects 82-104.

Aspect 1B—A user equipment (UE) for wireless communication, the UE comprising: one or more memories; and one or more processors in communication with the one or more memories, the one or more processors configured to: determine that a first condition is triggered for performing one or more layer 1 (L1) signal measurements for inter-cell mobility; perform the one or more L1 signal measurements of one or more cells in a configured cell set for the UE based on determining that the first condition is triggered; and send a report of the one or more L1 signal measurements to a network node.

Aspect 2B—The UE of Aspect 1B, wherein the one or more processors are further configured to: receive, from the network node, one or more conditions for triggering the one or more L1 signal measurements, wherein the one or more conditions includes the first condition.

Aspect 3B—The UE of Aspect 2B, wherein the one or more conditions include one or more of a UE mobility condition, a channel strength measurement condition associated with the configured cell set, or a predicted blocking condition.

Aspect 4B—The UE of Aspect 3B, wherein the first condition is the channel strength measurement condition, wherein the channel strength measurement condition is a channel strength threshold of one or more cells in the configured cell set, and wherein the one or more processors are further configured to: determine a channel strength of at least one cell of the one or more cells in the configured cell set; compare the channel strength to the channel strength threshold to generate a comparison; and determine, based on the comparison, that the channel strength measurement condition is triggered for performing the one or more L1 signal measurements for inter-cell mobility.

Aspect 5B—The UE of any of Aspects 1B-4B, wherein the one or more processors are further configured to: receive, from the network node, a measurement configuration that includes one or more measurement parameters for performing the one or more L1 signal measurements, wherein the one or more measurement parameters indicate one or more specific cells of the one or more cells in the configured cell set for which the one or more L1 signal measurements is to be performed; and perform, based on the one or more measurement parameters, the one or more L1 signal measurements of the one or more cells in the configured cell set.

Aspect 6B—The UE of any of Aspects 1B-5B, wherein the one or more processors are further configured to: receive, from the network node, a reporting configuration that includes reporting parameters for reporting the one or more L1 signal measurements, wherein the reporting parameters indicate one or more of a duration of the report, a number of reports, or a periodicity of multiple reports; and send, based on the reporting parameters, the report of the one or more L1 signal measurements to the network node using a downlink control information (DCI) signal or using a media access control (MAC) control element (CE) signal.

Aspect 7B—The UE of any of Aspects 1B-6B, wherein the one or more processors are further configured to: receive, from the network node, a dynamic grant of resources to use for reporting the one or more L1 signal measurements; and send, based on the dynamic grant of resources, the report of the one or more L1 signal measurements to the network node.

Aspect 8B—The UE of any of Aspects 1B-7B, wherein the one or more processors are further configured to: receive, from the network node, a filtering configuration that includes filtering parameters for filtering the one or more L1 signal measurements; and filter, based on the filtering parameters, the one or more L1 signal measurements prior to sending the report.

Aspect 9B—The UE of any of Aspects 1B-8B, wherein to perform the one or more L1 signal measurements of the one or more cells in the configured cell set, the one or more processors are configured to: perform the one or more L1 signal measurements of one or more cells in an activated cell set of the configured cell set; perform the one or more L1 signal measurements of one or more cells in a deactivated cell set of the configured cell set; or perform the one or more L1 signal measurements of one or more cells in the activated cell set of the configured cell set and perform the one or more L1 signal measurements of one or more cells in the deactivated cell set of the configured cell set.

Aspect 10B—A method for wireless communication, the method comprising: determining, at a user equipment (UE), that a first condition is triggered for performing one or more layer 1 (L1) signal measurements for inter-cell mobility; performing the one or more L1 signal measurements of one or more cells in a configured cell set for the UE based on determining that the first condition is triggered; and sending a report of the one or more L1 signal measurements to a network node.

Aspect 11B—The method of Aspect 10B, further comprising: receiving, from the network node, one or more conditions for triggering the one or more L1 signal measurements, wherein the one or more conditions includes the first condition.

Aspect 12B—The method of Aspect 11B, wherein the one or more conditions include one or more of a UE mobility condition, a channel strength measurement condition associated with the configured cell set, or a predicted blocking condition.

Aspect 13B—The method of Aspect 12B, wherein the first condition is the channel strength measurement condition, wherein the channel strength measurement condition is a channel strength threshold of one or more cells in the configured cell set, and wherein the method further comprises: determining a channel strength of at least one cell of the one or more cells in the configured cell set; comparing the channel strength to the channel strength threshold to generate a comparison; and determining, based on the comparison, that the channel strength measurement condition is triggered for performing the one or more L1 signal measurements for inter-cell mobility.

Aspect 14B—The method of any of Aspects 10B-13B, further comprising: receiving, from the network node, a measurement configuration that includes one or more measurement parameters for performing the one or more L1 signal measurements, wherein the one or more measurement parameters indicate one or more specific cells of the one or more cells in the configured cell set for which the one or more L1 signal measurements is to be performed; and performing, based on the one or more measurement parameters, the one or more L1 signal measurements of the one or more cells in the configured cell set.

Aspect 15B—The method of any of Aspects 10B-14B, further comprising: receiving, from the network node, a reporting configuration that includes reporting parameters for reporting the one or more L1 signal measurements, wherein the reporting parameters indicate one or more of a duration of the report, a number of reports, or a periodicity of multiple reports; and sending, based on the reporting parameters, the report of the one or more L1 signal measurements to the network node using a downlink control information (DCI) signal or using a media access control (MAC) control element (CE) signal.

Aspect 16B—The method of any of Aspects 10B-15B, further comprising: receiving, from the network node, a dynamic grant of resources to use for reporting the one or more L1 signal measurements; and sending, based on the dynamic grant of resources, the report of the one or more L1 signal measurements to the network node.

Aspect 17B—The method of any of Aspects 10B-16B, further comprising: receiving, from the network node, a filtering configuration that includes filtering parameters for filtering the one or more L1 signal measurements; and filtering, based on the filtering parameters, the one or more L1 signal measurements prior to sending the report.

Aspect 18B—The method of any of Aspects 10B-17B, wherein performing the one or more L1 signal measurements of the one or more cells in the configured cell set comprises: performing the one or more L1 signal measurements of one or more cells in an activated cell set of the configured cell set; performing the one or more L1 signal measurements of one or more cells in a deactivated cell set of the configured cell set; or performing the one or more L1 signal measurements of one or more cells in the activated cell set of the configured cell set and perform the one or more L1 signal measurements of one or more cells in the deactivated cell set of the configured cell set.

Aspect 19B—A network node for wireless communication, the network node comprising: one or more memories; and one or more processors in communication with the one or more memories, the one or more processors configured to: send, to a user equipment (UE), one or more conditions for triggering one or more layer 1 (L1) signal measurements of one or more cells in a configured cell set for the UE for inter-cell mobility; receive, from the UE, a report of the one or more L1 signal measurements; and perform an inter-cell mobility operation based on the one or more L1 signal measurements.

Aspect 20B—The network node of Aspect 19B, wherein the one or more conditions include one or more of a UE mobility condition, a channel strength measurement condition associated with the configured cell set, or a predicted blocking condition.

Aspect 21B—The network node of any of Aspects 19B-20B, wherein the one or more processors are further configured to: send, to the UE, a measurement configuration that includes one or more measurement parameters for performing the one or more L1 signal measurements, wherein the one or more measurement parameters indicate one or more specific cells of the one or more cells in the configured cell set for which the one or more L1 signal measurements is to be performed.

Aspect 22B—The network node of any of Aspects 19B-21B, wherein the one or more processors are further configured to: send, to the UE, a reporting configuration that includes reporting parameters for reporting the one or more L1 signal measurements, wherein the reporting parameters indicate one or more of a duration of the report, a number of reports, or a periodicity of multiple reports.

Aspect 23B—The network node of any of Aspects 19B-22B, wherein the one or more processors are further configured to: send, to the UE, a dynamic grant of resources to use for reporting the one or more L1 signal measurements.

Aspect 24B—The network node of any of Aspects 19B-23B, wherein the one or more processors are further configured to: filter the one or more L1 signal measurements.

Aspect 25B—A method for wireless communication, the method comprising:
sending, to a user equipment (UE), one or more conditions for triggering one or more layer 1 (L1) signal measurements of one or more cells in a configured cell set for the UE for inter-cell mobility; receiving, from the UE, a report of the one or more L1 signal measurements; and performing an inter-cell mobility operation based on the one or more L1 signal measurements.

Aspect 26B—The method of Aspect 25B, wherein the one or more conditions include one or more of a UE mobility condition, a channel strength measurement condition associated with the configured cell set, or a predicted blocking condition.

Aspect 27B—The method of any of Aspects 25B-26B, further comprising: sending, to the UE, a measurement configuration that includes one or more measurement parameters for performing the one or more L1 signal measurements, wherein the one or more measurement parameters indicate one or more specific cells of the one or more cells in the configured cell set for which the one or more L1 signal measurements is to be performed.

Aspect 28B—The method of any of Aspects 25B-27B, further comprising: sending, to the UE, a reporting configuration that includes reporting parameters for reporting the one or more L1 signal measurements, wherein the reporting parameters indicate one or more of a duration of the report, a number of reports, or a periodicity of multiple reports.

Aspect 29B—The method of any of Aspects 25B-28B, further comprising: sending, to the UE, a dynamic grant of resources to use for reporting the one or more L1 signal measurements.

Aspect 30B—The method of any of Aspects 25B-29B, further comprising: filtering the one or more L1 signal measurements.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described examples. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-11 may be rearranged and/or combined into a single component, step, feature or function or embodied in several components, steps, or functions. Additional elements, components, steps, and/or functions may also be added without departing from features disclosed herein. The apparatus, devices, and/or components illustrated in FIGS. 1-11 may be configured to perform one or more of the methods, features, or steps described herein. The techniques described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

Various examples have been described. These and other examples are within the scope of the following claims.

What is claimed is:

1. A user equipment (UE) for wireless communication, the UE comprising:
one or more memories; and
one or more processors in communication with the one or more memories, the one or more processors configured to:
determine that a first condition is triggered for performing one or more layer 1 (L1) signal measurements for inter-cell mobility;
perform the one or more L1 signal measurements of one or more cells in a configured cell set for the UE based on determining that the first condition is triggered; and
send a report of the one or more L1 signal measurements to a network node.

2. The UE of claim 1, wherein the one or more processors are further configured to:
receive, from the network node, one or more conditions for triggering the one or more L1 signal measurements, wherein the one or more conditions includes the first condition.

3. The UE of claim 2, wherein the one or more conditions include one or more of a UE mobility condition, a channel strength measurement condition associated with the configured cell set, or a predicted blocking condition.

4. The UE of claim 3, wherein the first condition is the channel strength measurement condition, wherein the channel strength measurement condition is a channel strength threshold of one or more cells in the configured cell set, and wherein the one or more processors are further configured to:
determine a channel strength of at least one cell of the one or more cells in the configured cell set;
compare the channel strength to the channel strength threshold to generate a comparison; and
determine, based on the comparison, that the channel strength measurement condition is triggered for performing the one or more L1 signal measurements for inter-cell mobility.

5. The UE of claim 1, wherein the one or more processors are further configured to:
receive, from the network node, a measurement configuration that includes one or more measurement parameters for performing the one or more L1 signal measurements, wherein the one or more measurement parameters indicate one or more specific cells of the one or more cells in the configured cell set for which the one or more L1 signal measurements is to be performed; and
perform, based on the one or more measurement parameters, the one or more L1 signal measurements of the one or more cells in the configured cell set.

6. The UE of claim 1, wherein the one or more processors are further configured to:
receive, from the network node, a reporting configuration that includes reporting parameters for reporting the one or more L1 signal measurements, wherein the reporting parameters indicate one or more of a duration of the report, a number of reports, or a periodicity of multiple reports; and
send, based on the reporting parameters, the report of the one or more L1 signal measurements to the network node using a downlink control information (DCI) signal or using a media access control (MAC) control element (CE) signal.

7. The UE of claim 1, wherein the one or more processors are further configured to:
receive, from the network node, a dynamic grant of resources to use for reporting the one or more L1 signal measurements; and
send, based on the dynamic grant of resources, the report of the one or more L1 signal measurements to the network node.

8. The UE of claim 1, wherein the one or more processors are further configured to:
receive, from the network node, a filtering configuration that includes filtering parameters for filtering the one or more L1 signal measurements; and
filter, based on the filtering parameters, the one or more L1 signal measurements prior to sending the report.

9. The UE of claim 1, wherein to perform the one or more L1 signal measurements of the one or more cells in the configured cell set, the one or more processors are configured to:
perform the one or more L1 signal measurements of one or more cells in an activated cell set of the configured cell set;
perform the one or more L1 signal measurements of one or more cells in a deactivated cell set of the configured cell set; or
perform the one or more L1 signal measurements of one or more cells in the activated cell set of the configured cell set and perform the one or more L1 signal measurements of one or more cells in the deactivated cell set of the configured cell set.

10. A method for wireless communication, the method comprising:
determining, at a user equipment (UE), that a first condition is triggered for performing one or more layer 1 (L1) signal measurements for inter-cell mobility;
performing the one or more L1 signal measurements of one or more cells in a configured cell set for the UE based on determining that the first condition is triggered; and
sending a report of the one or more L1 signal measurements to a network node.

11. The method of claim 10, further comprising:
receiving, from the network node, one or more conditions for triggering the one or more L1 signal measurements, wherein the one or more conditions includes the first condition.

12. The method of claim 11, wherein the one or more conditions include one or more of a UE mobility condition, a channel strength measurement condition associated with the configured cell set, or a predicted blocking condition.

13. The method of claim 12, wherein the first condition is the channel strength measurement condition, wherein the channel strength measurement condition is a channel strength threshold of one or more cells in the configured cell set, and wherein the method further comprises:
determining a channel strength of at least one cell of the one or more cells in the configured cell set;
comparing the channel strength to the channel strength threshold to generate a comparison; and
determining, based on the comparison, that the channel strength measurement condition is triggered for performing the one or more L1 signal measurements for inter-cell mobility.

14. The method of claim 10, further comprising:
receiving, from the network node, a measurement configuration that includes one or more measurement parameters for performing the one or more L1 signal measurements, wherein the one or more measurement parameters indicate one or more specific cells of the one or more cells in the configured cell set for which the one or more L1 signal measurements is to be performed; and
performing, based on the one or more measurement parameters, the one or more L1 signal measurements of the one or more cells in the configured cell set.

15. The method of claim 10, further comprising:
receiving, from the network node, a reporting configuration that includes reporting parameters for reporting the one or more L1 signal measurements, wherein the reporting parameters indicate one or more of a duration of the report, a number of reports, or a periodicity of multiple reports; and
sending, based on the reporting parameters, the report of the one or more L1 signal measurements to the network node using a downlink control information (DCI) signal or using a media access control (MAC) control element (CE) signal.

16. The method of claim 10, further comprising:
receiving, from the network node, a dynamic grant of resources to use for reporting the one or more L1 signal measurements; and
sending, based on the dynamic grant of resources, the report of the one or more L1 signal measurements to the network node.

17. The method of claim 10, further comprising:
receiving, from the network node, a filtering configuration that includes filtering parameters for filtering the one or more L1 signal measurements; and
filtering, based on the filtering parameters, the one or more L1 signal measurements prior to sending the report.

18. The method of claim 10, wherein performing the one or more L1 signal measurements of the one or more cells in the configured cell set comprises:
performing the one or more L1 signal measurements of one or more cells in an activated cell set of the configured cell set;
performing the one or more L1 signal measurements of one or more cells in a deactivated cell set of the configured cell set; or
performing the one or more L1 signal measurements of one or more cells in the activated cell set of the configured cell set and perform the one or more L1 signal measurements of one or more cells in the deactivated cell set of the configured cell set.

19. A network node for wireless communication, the network node comprising:
one or more memories; and
one or more processors in communication with the one or more memories, the one or more processors configured to:
send, to a user equipment (UE), one or more conditions for triggering one or more layer 1 (L1) signal measurements of one or more cells in a configured cell set for the UE for inter-cell mobility;
receive, from the UE, a report of the one or more L1 signal measurements; and
perform an inter-cell mobility operation based on the one or more L1 signal measurements.

20. The network node of claim 19, wherein the one or more conditions include one or more of a UE mobility condition, a channel strength measurement condition associated with the configured cell set, or a predicted blocking condition.

21. The network node of claim 19, wherein the one or more processors are further configured to:
send, to the UE, a measurement configuration that includes one or more measurement parameters for performing the one or more L1 signal measurements, wherein the one or more measurement parameters indicate one or more specific cells of the one or more cells in the configured cell set for which the one or more L1 signal measurements is to be performed.

22. The network node of claim 19, wherein the one or more processors are further configured to:
send, to the UE, a reporting configuration that includes reporting parameters for reporting the one or more L1 signal measurements, wherein the reporting parameters indicate one or more of a duration of the report, a number of reports, or a periodicity of multiple reports.

23. The network node of claim 19, wherein the one or more processors are further configured to:
send, to the UE, a dynamic grant of resources to use for reporting the one or more L1 signal measurements.

24. The network node of claim 19, wherein the one or more processors are further configured to:
filter the one or more L1 signal measurements.

25. A method for wireless communication, the method comprising:
sending, to a user equipment (UE), one or more conditions for triggering one or more layer 1 (L1) signal measurements of one or more cells in a configured cell set for the UE for inter-cell mobility;
receiving, from the UE, a report of the one or more L1 signal measurements; and
performing an inter-cell mobility operation based on the one or more L1 signal measurements.

26. The method of claim 25, wherein the one or more conditions include one or more of a UE mobility condition, a channel strength measurement condition associated with the configured cell set, or a predicted blocking condition.

27. The method of claim 25, further comprising:
sending, to the UE, a measurement configuration that includes one or more measurement parameters for performing the one or more L1 signal measurements, wherein the one or more measurement parameters indicate one or more specific cells of the one or more cells in the configured cell set for which the one or more L1 signal measurements is to be performed.

28. The method of claim 25, further comprising:
sending, to the UE, a reporting configuration that includes reporting parameters for reporting the one or more L1 signal measurements, wherein the reporting parameters indicate one or more of a duration of the report, a number of reports, or a periodicity of multiple reports.

29. The method of claim 25, further comprising:
sending, to the UE, a dynamic grant of resources to use for reporting the one or more L1 signal measurements.

30. The method of claim 25, further comprising:
filtering the one or more L1 signal measurements.
